(19) United States
(12) Patent Application Publication
(10) Pub. No.: US 2025/0172186 A1
(43) Pub. Date: May 29, 2025

(54) SHOCK ABSORBER AND DAMPING VALVE DEVICE

(71) Applicant: Hitachi Astemo, Ltd., Ibaraki (JP)

(72) Inventors: Mikio YAMASHITA, Hitachinaka-shi (JP); Takamasa KOTANI, Hitachinaka-shi (JP); Tsutomu NAITO, Hitachinaka-shi (JP)

(21) Appl. No.: 18/842,459

(22) PCT Filed: Mar. 7, 2023
(86) PCT No.: PCT/JP2023/008526

§ 371 Date: Aug. 29, 2024

(30) Foreign Application Priority Data
May 27, 2022 (JP) 2022-086551

(51) Int. Cl. F16F 9/32; F16F 9/348

(52) U.S. Cl. CPC F16F 9/3257; F16F 9/348

(57) ABSTRACT

A shock absorber has a first passage through which a working fluid flows due to movement of a piston in a cylinder in one direction, a first damping valve providing resistance to the working fluid flowing from a chamber upstream of a chamber on a downstream side of the first passage, a second passage through which the working fluid flows due to movement of the piston in the other direction, and a second damping disc valve providing resistance to the working fluid from a chamber upstream of a chamber on a downstream side of the second passage. The second damping disc valve includes a third passage which allows communication between a chamber on an upstream side and a chamber on a downstream side, and a fourth passage communicating with a chamber on an upstream side, and a variable chamber communicating with the fourth passage and partitioned by a partition member.

### TECHNICAL FIELD

The present invention relates to a shock absorber and a damping valve device.

Priority is claimed on Japanese Patent Application No. 2022-086551, filed May 27, 2022, the content of which is incorporated herein by reference.

### BACKGROUND ART

Some shock absorbers have a body valve (for example, Patent Documents 1 and 2).

### CITATION LIST

### Patent Document

### Patent Document 1

Japanese Unexamined Patent Application, First Publication No. 2009-287752

### Patent Document 2

Japan Patent No. 5443227

### SUMMARY OF INVENTION

### Technical Problem

Incidentally, there has been a demand to suppress occurrence of abnormal noise in a shock absorber.

Accordingly, an objective of the present invention is to provide a shock absorber and a damping valve device capable of suppressing occurrence of abnormal noise.

### Solution to Problem

One aspect of a shock absorber according to the present invention includes a cylinder in which a working fluid is sealed, a piston fitted in the cylinder and partitioning the inside of the cylinder, a first passage through which a flow of the working fluid occurs due to movement of the piston in one direction, a first damping valve providing resistance to a flow of the working fluid from a chamber on an upstream side to a chamber on a downstream side of the first passage, a second passage through which a flow of the working fluid occurs due to movement of the piston in the other direction, and a second damping disc valve providing resistance to a flow of the working fluid from a chamber on an upstream side to a chamber on a downstream side of the second passage, in which the second damping disc valve includes a third passage which allows constant communication between a chamber on an upstream side and a chamber on a downstream side, and a fourth passage communicating with a chamber on an upstream side, and a variable chamber communicating with the fourth passage and partitioned by a partition member, which is movable according to a change in pressure of a chamber on an upstream side or a downstream side, is disposed to overlap the second damping disc valve.

One aspect of a damping valve device according to the present invention is a damping valve device communicating with a cylinder in which a working fluid is sealed, and includes a first passage through which a flow of the working fluid occurs due to movement of a piston in the cylinder in one direction, a first damping valve providing resistance to a flow of the working fluid from a chamber on an upstream side to a chamber on a downstream side of the first passage, a second passage through which a flow of the working fluid occurs due to movement of the piston in the other direction, and a second damping disc valve providing resistance to a flow of the working fluid from a chamber on an upstream side to a chamber on a downstream side of the second passage, in which the second damping disc valve has a communication passage communicating with a chamber on an upstream side, and a pressure accumulation mechanism having a variable chamber which communicates with the communication passage and is partitioned by a partition member, which is movable according to a change in pressure of a chamber on an upstream side or a downstream side, is disposed to overlap the second damping disc valve.

### Advantageous Effects of Invention

According to each of the above-described aspects of the present invention, it is possible to suppress occurrence of abnormal noise.

### BRIEF DESCRIPTION OF DRAWINGS

FIG. 1 is a cross-sectional view showing a shock absorber of a first embodiment according to the present invention.

FIG. 2 is a partial cross-sectional view showing a body valve of the shock absorber of the first embodiment and a vicinity thereof.

FIG. 3 is a partial cross-sectional view showing part III in FIG. 2 of the body valve of the shock absorber of the first embodiment.

FIG. 4 is a hydraulic circuit diagram of the body valve of the shock absorber of the first embodiment.

FIG. 5 is a characteristic diagram showing a simulation result of a rod acceleration during transition from a compression stroke to an extension stroke in the shock absorber of the first embodiment and a shock absorber of a comparative example.

FIG. 6 is a characteristic diagram showing characteristics of a damping force with respect to a piston speed at a low piston frequency when the piston speed is high in the shock absorber of the first embodiment and the shock absorber of the comparative example.

FIG. 7 is a characteristic diagram showing characteristics of a damping force with respect to a piston speed at a low piston frequency when the piston speed is low in the shock absorber of the first embodiment and the shock absorber of the comparative example.

FIG. 8 is a characteristic diagram showing characteristics of a damping force with respect to a piston speed at a high piston frequency when the piston speed is high in the shock absorber of the first embodiment and the shock absorber of the comparative example.

FIG. 9 is a characteristic diagram showing characteristics of a damping force with respect to a piston speed at a high piston frequency when the piston speed is low in the shock absorber of the first embodiment and the shock absorber of the comparative example.

FIG. 10 is a characteristic diagram showing characteristics of a damping force with respect to a piston frequency when the piston speed is high in the shock absorber of the first embodiment and the shock absorber of the comparative example.

FIG. 11 is a partial cross-sectional view showing a main part of a body valve of a shock absorber of a second embodiment according to the present invention.

FIG. 12 is a partial cross-sectional view showing a main part of a body valve of a shock absorber of a third embodiment according to the present invention.

FIG. 13 is a partial cross-sectional view showing a partition member of the shock absorber of the third embodiment.

FIG. 14 is the bottom view showing the partition member of the shock absorber of the third embodiment.

FIG. 15 is a partial cross-sectional view showing a main part of a body valve of a shock absorber of a fourth embodiment according to the present invention.

FIG. 16 is a partial cross-sectional view showing a partition member of the shock absorber of the fourth embodiment.

FIG. 17 is a plan view showing the partition member of the shock absorber of the fourth embodiment.

FIG. 18 is a hydraulic circuit diagram of the body valve of the shock absorber of the fourth embodiment.

FIG. 19 is a partial cross-sectional view showing a partition member of a shock absorber of a fifth embodiment according to the present invention.

FIG. 20 is a plan view showing the partition member of the shock absorber of the fifth embodiment.

FIG. 21 is a partial cross-sectional view showing a main part of a body valve of a shock absorber of a sixth embodiment according to the present invention.

### DESCRIPTION OF EMBODIMENTS

### First Embodiment

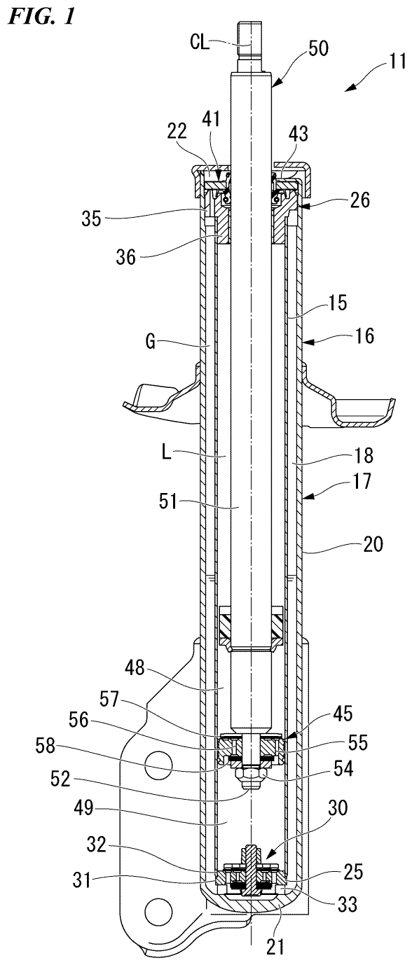

A first embodiment according to the present invention will be described below with reference to FIGS. 1 to 10.

FIG. 1 shows a shock absorber 11 of the first embodiment. This shock absorber 11 is a shock absorber used in a suspension device of a vehicle such as an automobile or a railway vehicle. The shock absorber 11 is a hydraulic shock absorber used in, specifically, suspension devices of automobiles. The shock absorber 11 includes a cylinder 17 having an inner cylinder 15 and an outer cylinder 16. The inner cylinder 15 has a cylindrical shape. The outer cylinder 16 has a bottomed cylindrical shape. An inner diameter of the outer cylinder 16 is larger than an outer diameter of the inner cylinder 15. The outer cylinder 16 is provided coaxially with the inner cylinder 15 outside the inner cylinder 15 in a radial direction. A reservoir chamber 18 is provided between the outer cylinder 16 and the inner cylinder 15. The shock absorber 11 is a dual-tube type shock absorber.

The outer cylinder 16 has a barrel part 20 and a bottom part 21. The barrel part 20 has a cylindrical shape. The bottom part 21 closes an end portion of the barrel part 20 on one side in an axial direction. An end portion of the barrel part 20 on a side opposite to the bottom part 21 is an opening 22. The opening 22 of the outer cylinder 16 is also provided at one end of the cylinder 17 in the axial direction. The bottom part 21 of the outer cylinder 16 is also provided at the other end of the cylinder 17 in the axial direction. In other words, the cylinder 17 has one axial end that is open to serve as the opening 22, and the other axial end that is closed to serve as the bottom part 21.

The shock absorber 11 includes a valve base 25 and a rod guide 26.

The valve base 25 has an annular shape and is provided at one end portion of the inner cylinder 15 and the outer cylinder 16 in the axial direction. The valve base 25 constitutes a body valve 30 serving as a damping valve device. In the valve base 25, one axial side of an outer circumferential portion is a large diameter part 31, and the other axial side of the outer circumferential portion is a small diameter part 32. An outer diameter of the large diameter part 31 is larger than an outer diameter of the small diameter part 32. Therefore, the outer circumferential portion of the valve base 25 is formed in a stepped shape.

The valve base 25 is placed on the bottom part 21 with the large diameter part 31 side in the axial direction positioned at the bottom part 21 side with respect to the small diameter part 32 side. At that time, the valve base 25 is positioned in the radial direction with respect to the outer cylinder 16 at the large diameter part 31. The valve base 25 includes a passage groove 33 penetrating the valve base 25 in the radial direction formed at a position of the large diameter part 31 in the axial direction. Here, a space between the valve base 25 and the bottom part 21 communicates with a space between the inner cylinder 15 and the outer cylinder 16 via the passage groove 33 formed on the valve base 25. The space between the valve base 25 and the bottom part 21 constitutes the reservoir chamber 18 similarly to the space between the inner cylinder 15 and the outer cylinder 16.

The rod guide 26 has an annular shape, and is provided at the other axial end portion of the inner cylinder 15 and the outer cylinder 16. The rod guide 26 is provided on the opening 22 side of the cylinder 17. The rod guide 26 has a large diameter part 35 on one axial side of an outer circumferential portion, and a small diameter part 36 on the other axial side of the outer circumferential portion. An outer diameter of the large diameter part 35 is larger than an outer diameter of the small diameter part 36. Therefore, the outer circumferential portion of the rod guide 26 is formed in a stepped shape. The rod guide 26 fits to an inner circumferential portion of the barrel part 20 of the outer cylinder 16 on the opening 22 side at the large diameter part 35 with the small diameter part 36 positioned on the bottom part 21 side with respect to the large diameter part 35.

One end portion of the inner cylinder 15 in the axial direction is fitted onto the small diameter part 32 of the outer circumferential portion of the valve base 25. One end portion of the inner cylinder 15 in the axial direction is placed on the bottom part 21 of the outer cylinder 16 via the valve base 25. Also, the other end portion of the inner cylinder 15 in the axial direction is fitted onto the small diameter part 36 of the rod guide 26. The other end portion of the inner cylinder 15 is fitted to the barrel part 20 of the outer cylinder 16 via the rod guide 26. In this state, the inner cylinder 15 is positioned in the axial direction and radial direction with respect to the outer cylinder 16.

The shock absorber 11 includes an annular rod seal 41. The rod seal 41 is provided on a side of the rod guide 26 opposite to the bottom part 21 in an axial direction of the cylinder 17. The rod seal 41 is also fitted to the inner circumferential portion of the barrel part 20 similarly to the rod guide 26. A locking part 43 is formed in the outer cylinder 16 at an end portion of the barrel part 20 on a side opposite to the bottom part 21. The locking part 43 is formed by plastically deforming the barrel part 20 inward in the radial direction by swaging processing such as curling processing. The rod seal 41 is sandwiched between the locking part 43 and the rod guide 26. At that time, the rod seal 41 is pressed against an inner circumferential surface of the barrel part 20 by the rod guide 26. Thereby, the rod seal 41 closes the opening 22 of the outer cylinder 16. The rod seal 41 is specifically an oil seal.

The shock absorber 11 includes a piston 45. The piston 45 is slidably fitted in the inner cylinder 15 of the cylinder 17. The piston 45 partitions the inside of the inner cylinder 15 into two chambers including a first chamber 48 and a second chamber 49. The first chamber 48 is provided between the piston 45 and the rod guide 26 inside the inner cylinder 15. The second chamber 49 is provided between the piston 45 and the valve base 25 inside the inner cylinder 15. The second chamber 49 is partitioned from the reservoir chamber 18 by the valve base 25. In the cylinder 17, an oil fluid L is sealed as a working fluid in the first chamber 48 and the second chamber 49. In the cylinder 17, a gas G and the oil fluid L are sealed as working fluids in the reservoir chamber 18.

The shock absorber 11 includes a piston rod 50. One end portion of the piston rod 50 in the axial direction is inserted inside the cylinder 17. The portion of the piston rod 50 on this one end side is connected to the piston 45. An intermediate portion of the piston rod 50 in the axial direction passes through the rod guide 26 and the rod seal 41. A portion of the piston rod 50 on the other end side in the axial direction extends to the outside of the cylinder 17. The piston rod 50 is made of a metal and penetrates the inside of the first chamber 48. The piston rod 50 does not penetrate the second chamber 49. Therefore, the first chamber 48 is a rod side chamber through which the piston rod 50 penetrates. The second chamber 49 is a bottom side chamber of the cylinder 17 on the bottom part 21 side. The portion of the piston rod 50 extending to the outside from the cylinder 17 is connected to a vehicle body side of a vehicle.

The piston rod 50 has a main shaft part 51 and a mounting shaft part 52.

The mounting shaft part 52 has an outer diameter smaller than an outer diameter of the main shaft part 51. The piston rod 50 is inserted into the cylinder 17 on the mounting shaft part 52 side.

The main shaft part 51 of the piston rod 50 passes through the rod guide 26 and the rod seal 41. The rod guide 26 and the rod seal 41 are provided at a portion on a side of the cylinder 17 from which the piston rod 50 extends. The rod guide 26 supports the piston rod 50 to be slidable. The piston rod 50 is guided by the rod guide 26 at an outer circumferential surface of the main shaft part 51. The piston rod 50, together with the piston 45, moves in the axial direction with respect to the cylinder 17. In an extension stroke of the shock absorber 11 in which the piston rod 50 increases a protrusion amount thereof from the cylinder 17, the piston 45 moves to the first chamber 48 side. In a compression stroke of the shock absorber 11 in which the piston rod 50 reduces a protrusion amount thereof from the cylinder 17, the piston 45 moves to the second chamber 49 side.

The rod seal 41 is provided on a side of the cylinder 17 from which the piston rod 50 extends, that is, on the opening 22 side of the outer cylinder 16. The rod seal 41, together with the rod guide 26, seals a space between the barrel part 20 of the outer cylinder 16 and the main shaft part 51 of the piston rod 50, and restricts leakage of the oil fluid L inside the inner cylinder 15 and the gas G and the oil fluid L inside the reservoir chamber 18 to the outside.

A passage 55 and a passage 56 are formed in the piston 45. Both the passage 55 and the passage 56 penetrate the piston 45 in the axial direction. The passages 55 and 56 allow communication between the first chamber 48 and the second chamber 49. The shock absorber 11 includes a disc valve 57 and a disc valve 58. The disc valve 57 is provided on a side of the piston 45 opposite to the bottom part 21 in the axial direction. The disc valve 57 has an annular shape and closes the passage 55 by coming into contact with the piston 45. The disc valve 58 is provided on the bottom part 21 side of the piston 45 in the axial direction. The disc valve 58 has an annular shape and closes the passage 56 by coming into contact with the piston 45. The disc valves 57 and 58 are attached to the piston rod 50 along with the piston 45.

When the piston rod 50 moves to a compression side that increases an amount of entry into the inner cylinder 15 and the outer cylinder 16 to move the piston 45 in a direction in which the second chamber 49 is reduced, a pressure in the second chamber 49 becomes higher than a pressure in the first chamber 48. Then, the disc valve 57 opens the passage 55 to allow the oil fluid L in the second chamber 49 to flow into the first chamber 48. At that time, the disc valve 57 generates a damping force.

When the piston rod 50 moves to an extension side that increases an amount of protrusion from the inner cylinder 15 and the outer cylinder 16 to move the piston 45 in a direction in which the first chamber 48 is reduced, a pressure in the first chamber 48 becomes higher than a pressure in the second chamber 49. Then, the disc valve 58 opens the passage 56 to allow the oil fluid L in the first chamber 48 to flow into the second chamber 49. At that time, the disc valve 58 generates a damping force.

A fixed orifice (not shown) is formed in at least one of the piston 45 and the disc valve 57. This fixed orifice allows communication between the first chamber 48 and the second chamber 49 through the passage 55 even in a state in which the disc valve 57 has closed the passage 55 to the maximum.

A fixed orifice (not shown) is also formed in at least one of the piston 45 and the disc valve 58. This fixed orifice allows communication between the first chamber 48 and the second chamber 49 through the passage 56 even in a state in which the disc valve 58 has closed the passage 56 to the maximum.

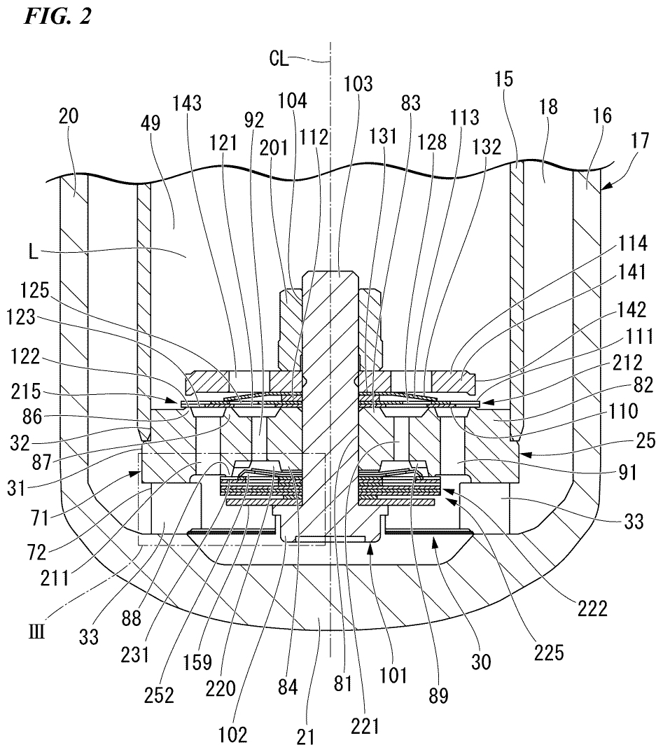

The body valve 30 includes the valve base 25 that partitions the second chamber 49 and the reservoir chamber 18 as described above. The valve base 25 is an integrally molded product made of a metal and formed without any seams. The valve base 25 includes a base part 71 and a leg part 72 as shown in FIG. 2.

The base part 71 has a perforated disc shape.

The leg part 72 has a cylindrical shape and extends from an outer circumferential portion of the base part 71 to one side in an axial direction of the base part 71. A part of the large diameter part 31 is formed at the leg part 72, and a remaining portion of the large diameter part 31 and the small diameter part 32 are formed at the base part 71. The above-described passage groove 33 penetrating the leg part 72 in the radial direction is formed in the leg part 72. The passage groove 33 opens at an end portion of the leg part 72 on a side opposite to the base part 71 in the axial direction. A plurality of passage grooves 33 are formed in the leg part 72 at intervals in a circumferential direction thereof. The valve base 25 is placed on the bottom part 21 of the outer cylinder 16 at an end portion of the leg part 72 on a side opposite to the base part 71 in the axial direction. At that time, the valve base 25 is positioned in the radial direction with respect to the outer cylinder 16.

A through hole 81 is formed in the base part 71 of the valve base 25 at a center in the radial direction. The base part 71 has a base main body part 82, an inner seat 83, and an inner seat 84.

The inner seat 83 has an annular shape, and protrudes from an entire circumference of an end edge portion of the base main body part 82 on the through hole 81 side in the radial direction to a side opposite to the leg part 72 in an axial direction of the base main body part 82.

The inner seat 84 has an annular shape, and protrudes from an entire circumference of an end edge portion of the base main body part 82 on the through hole 81 side in the radial direction to the leg part 72 side in the axial direction of the base main body part 82.

The base part 71 has an outer seat 86 and an intermediate seat 87.

The outer seat 86 has an annular shape, and protrudes from a portion of the base main body part 82 on an outer side of the inner seat 83 in the radial direction to a side opposite to the leg part 72 in the axial direction of the base main body part 82.

The intermediate seat 87 has an annular shape, and protrudes from a position of the base main body part 82 between the outer seat 86 and the inner seat 83 in the radial direction to a side opposite to the leg part 72 in the axial direction of the base main body part 82.

Also, the base part 71 has an outer seat 88. The outer seat 88 has an annular shape, and protrudes from a position of the base main body part 82 between the leg part 72 and the inner seat 84 in the radial direction to the leg part 72 side in the axial direction of the base main body part 82.

Also, the base part 71 has a protruding part 89. The protruding part 89 protrudes to the same side as the outer seat 88 in the axial direction of the base main body part 82 from the base main body part 82. The protruding part 89 extends inward in a radial direction of the outer seat 88 from the outer seat 88. In the axial direction of the base main body part 82, a protrusion height of the protruding part 89 from the base main body part 82 is smaller than a protrusion height of the outer seat 88 from the base main body part 82. A plurality of protruding parts 89 of the same shape are formed in the base part 71 at regular intervals in a circumferential direction of the base part 71.

An outer passage hole 91 penetrating the base main body part 82 in the axial direction is formed in the base main body part 82 between the outer seat 86 and the intermediate seat 87 in the radial direction. A plurality of outer passage holes 91 are provided in the base main body part 82 at regular intervals in a circumferential direction of the base main body part 82. The plurality of outer passage holes 91 are disposed between the outer seat 88 and the leg part 72 in the radial direction of the base main body part 82. The second chamber 49 and the reservoir chamber 18 are allowed to communicate with each other by the plurality of outer passage holes 91.

An inner passage hole 92 penetrating the base main body part 82 in the axial direction is formed in the base main body part 82 between the inner seat 83 and the intermediate seat 87 in the radial direction. A plurality of inner passage holes 92 are provided in the base main body part 82 at regular intervals in the circumferential direction of the base main body part 82. The plurality of inner passage holes 92 are disposed between the outer seat 88 and the inner seat 84 in the radial direction of the base main body part 82. The second chamber 49 and the reservoir chamber 18 are allowed to communicate with each other by the plurality of inner passage holes 92.

The body valve 30 includes a pin member 101 inserted into the through hole 81 of the valve base 25. The pin member 101 is a bolt, and has a head part 102 and a shaft part 103 which has an outer diameter smaller than an outer diameter of the head part 102.

The head part 102 is engageable with a fastening tool.

The shaft part 103 has a columnar shape and extends to one side in an axial direction of the head part 102 from a center in a radial direction of the head part 102. A male screw 104 is formed on an outer circumferential portion of the shaft part 103 on a side opposite to the head part 102 in the axial direction.

The body valve 30 includes one valve disc 110, one valve disc 111, one disc 112, one spring disc 113, and one restriction disc 114 on a side of the valve base 25 opposite to the bottom part 21 in the axial direction in order from the valve base 25 side in the axial direction. The valve discs 110 and 111, the disc 112, the spring disc 113, and the restriction disc 114 are all made of a metal. The valve discs 110 and 111 and the disc 112 all have a perforated disc shape with a constant thickness into which the shaft part 103 of the pin member 101 can be fitted.

The valve disc 110 has an outer diameter that is slightly larger than an outer diameter of the outer seat 86 of the valve base 25. The valve disc 110 is bendable and closes the outer passage hole 91 by coming into contact with the inner seat 83, the outer seat 86, and the intermediate seat 87. A passage hole 121 penetrating the valve disc 110 in the axial direction is formed in the valve disc 110 between the inner seat 83 and the intermediate seat 87 in the radial direction. The passage hole 121 is an elongated hole extending in a circumferential direction of the valve disc 110. A notch 122 is formed on an outer circumferential side of the valve disc 110. The notch 122 crosses a contact portion of the outer seat 86 to the valve disc 110 in the radial direction. Inside the notch 122 serves as an orifice 123.

The valve disc 111 has an outer diameter the same as an outer diameter of the valve disc 110. The valve disc 111 is bendable and is in contact with the valve disc 110. A passage hole 125 penetrating the valve disc 111 in the axial direction is formed in the valve disc 111 between the inner seat 83 and the outer seat 86 in the radial direction. A plurality of passage holes 125 are formed in the valve disc 111 at regular intervals in a circumferential direction of the valve disc 111. In the radial direction of the valve discs 110 and 111, the passage hole 125 is offset from the notch 122 in position and partially overlaps the passage hole 121. A communication portion between the passage hole 121 and the passage hole 125 serves as an orifice 128.

The disc 112 has an outer diameter the same as an outer diameter of the inner seat 83 of the valve base 25, and the entirety is disposed inward of the passage hole 125 in a radial direction of the valve disc 111.

The spring disc 113 has a base plate part 131 and a spring plate part 132.

The base plate part 131 has a perforated disc shape with a constant thickness, and the shaft part 103 of the pin member 101 can be fitted inside the base plate part 131. The base plate part 131 has an outer diameter that is slightly larger than an outer diameter of the disc 112.

The spring plate part 132 extends outward in the radial direction from an outer circumferential edge portion of the base plate part 131. The spring plate part 132 is bendable. A plurality of spring plate parts 132 are formed in the spring disc 113 at regular intervals in a circumferential direction of the base plate part 131. The spring plate part 132 is inclined with respect to the base plate part 131 such that it becomes further away from the base plate part 131 in an axial direction of the base plate part 131 toward the outside in a radial direction of the base plate part 131. The plurality of spring plate parts 132 all extend to the same side in the axial direction of the base plate part 131 with respect to the base plate part 131. The spring disc 113 is in contact with the disc 112 at the base plate part 131, and the plurality of spring plate parts 132 extend from the base plate part 131 to the valve disc 111 side in the axial direction to be in contact with an annular portion on an outer side of the passage hole 125 in the radial direction of the valve disc 111.

The restriction disc 114 has a larger thickness and a higher rigidity than the valve discs 110 and 111 and the spring disc 113. The restriction disc 114 has a main plate part 141 and an outer circumferential stepped part 142.

The main plate part 141 has a perforated disc shape with a constant thickness, and the shaft part 103 of the pin member 101 can be fitted inside the main plate part 141.

The outer circumferential stepped part 142 has an annular shape and protrudes outward in the radial direction from an entire outer circumference of the main plate part 141. The outer circumferential stepped part 142 is formed slightly offset to one side in the axial direction with respect to the main plate part 141. The restriction disc 114 is in contact with the base plate part 131 of the spring disc 113 at the main plate part 141, and the outer circumferential stepped part 142 protrudes to the valve disc 111 side in the axial direction with respect to the main plate part 141. A passage hole 143 penetrating the main plate part 141 in the axial direction is formed in the main plate part 141 at a predetermined intermediate position in the radial direction. A plurality of passage holes 143 are formed in the main plate part 141 at regular intervals in a circumferential direction of the main plate part 141. The passage hole 143 allows the second chamber 49 to constantly communicate with the inner passage hole 92 of the valve base 25 through a gap between the spring plate parts 132 of the spring disc 113, the passage hole 125 of the valve disc 111, and the passage hole 121 of the valve disc 110.

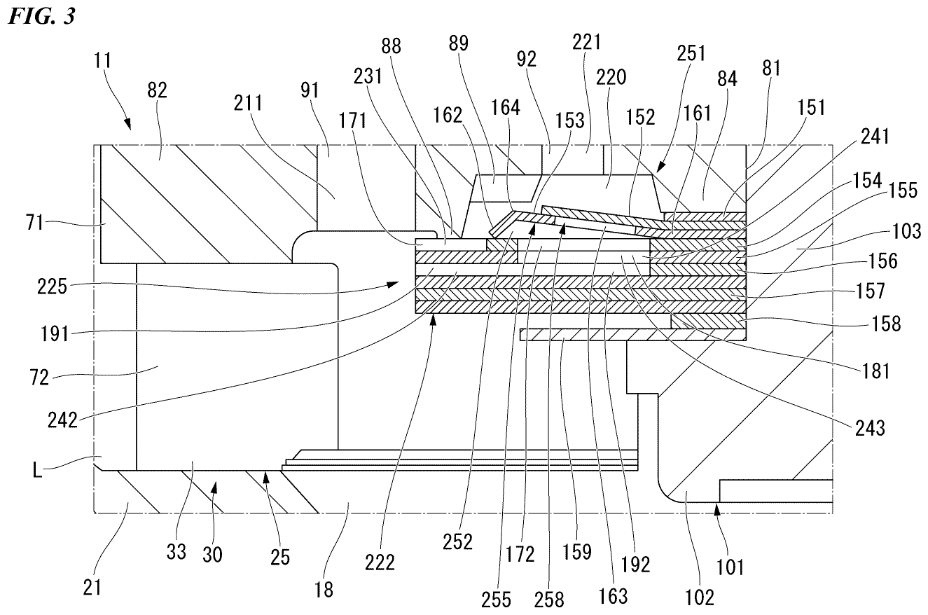

As shown in FIG. 3, the body valve 30 includes one disc 151, one opening/closing disc 152, one disc spring 153, one valve disc 154, one valve disc 155, one valve disc 156, a plurality of, specifically three, valve discs 157, one disc 158, and one disc 159 on the leg part 72 side of the valve base 25 in the axial direction of the base part 71 in order from the base part 71 side in the axial direction.

The discs 151 and 158, the opening/closing disc 152, the disc spring 153, the valve discs 154 to 157, and the disc 159 are all made of a metal. The discs 151 and 158, the valve discs 154 to 157, and the disc 159 all have a perforated disc shape with a constant thickness into which the shaft part 103 of the pin member 101 can be fitted. Both the opening/closing disc 152 and the disc spring 153 have an annular shape into which the shaft part 103 of the pin member 101 can be fitted.

The disc 151 has an outer diameter that is slightly smaller than an outer diameter of the inner seat 84 of the valve base 25.

The opening/closing disc 152 has a perforated disc shape with a constant thickness in a natural state before being incorporated into the body valve 30. The opening/closing disc 152 is bendable. The opening/closing disc 152 has an outer diameter larger than an outer diameter of the disc 151. The opening/closing disc 152 has an outer diameter that does not come into contact with the plurality of protruding parts 89 of the valve base 25. The disc spring 153 is formed by press-forming one plate material having a flat plate shape. The disc spring 153 has a base plate part 161 and an outer circumferential tapered plate part 162. The disc spring 153 is bendable.

When the disc spring 153 is in a natural state before being incorporated into the body valve 30, the base plate part 161 has a perforated disc shape with a constant thickness. A passage hole 163 penetrating the base plate part 161 in an axial direction of the base plate part 161 is formed in the base plate part 161 at a position of larger diameter than an outer diameter of the disc 151 and smaller diameter than an outer diameter of the opening/closing disc 152. A plurality of passage holes 163 are formed in the base plate part 161 at regular intervals in a circumferential direction of the base plate part 161.

The outer circumferential tapered plate part 162 extends in a tapered shape from an outer circumferential edge portion of the base plate part 161. The outer circumferential tapered plate part 162 becomes larger in diameter with distance away from the base plate part 161 having a flat plate shape in the axial direction of the base plate part 161. The outer circumferential tapered plate part 162 has an annular shape and is formed over the entire circumference of the base plate part 161.

In the disc spring 153, a boundary between the base plate part 161 and the outer circumferential tapered plate part 162 is a corner portion 164. The corner portion 164 is provided over the entire circumference of the disc spring 153 and has a circular shape.

The valve disc 154 has an outer diameter that is slightly larger than an outer diameter of the outer seat 88 of the valve base 25. The valve disc 154 is bendable and is in contact with the disc spring 153 and the outer seat 88. A notch 171 is formed on an outer circumferential side of the valve disc 154. The notch 171 crosses a contact portion of the outer seat 88 to the valve disc 154 in the radial direction. A plurality of notches 171 are formed in the valve disc 154 at regular intervals in a circumferential direction of the valve disc 154. A passage hole 172 penetrating the valve disc 154 in an axial direction of the valve disc 154 is formed in the valve disc 154. The passage hole 172 is provided at a position radially inward of an inscribed circle of the plurality of notches 171 of the valve disc 154. The passage hole 172 is an arc-shaped elongated hole extending in the circumferential direction of the valve disc 154.

The valve disc 155 has an outer diameter the same as an outer diameter of the valve disc 154. The valve disc 155 is bendable. A passage hole 181 penetrating the valve disc 155 in an axial direction of the valve disc 155 is formed in the valve disc 155. The passage hole 181 is provided at a position overlapping the passage hole 172 of the valve disc 154 in the radial direction of the valve discs 154 and 155. The passage hole 181 is an arc-shaped elongated hole extending in a circumferential direction of the valve disc 155.

The valve disc 156 has an outer diameter the same as an outer diameter of the valve discs 154 and 155. The valve disc 156 is bendable. A notch 191 is formed on an outer circumferential side of the valve disc 156. A passage hole 192 penetrating the valve disc 156 in an axial direction of the valve disc 156 is formed in the valve disc 156. The passage hole 192 is provided at a position overlapping the passage hole 181 of the valve disc 155 in the radial direction of the valve discs 155 and 156. The passage hole 192 is an arc-shaped elongated hole extending in the circumferential direction of the valve disc 154. The notch 191 communicates with the passage hole 192.

The passage holes 172, 181, and 192, all of which have an elongated hole shape that is long in the circumferential direction of the valve discs 154 to 156, overlap in position in the radial direction of the valve discs 154 to 156. Thereby, an area in which the passage holes 172, 181, and 192 overlap each other can be sufficiently secured regardless of phases of the valve discs 154 to 156.

The plurality of valve disc 157 have an outer diameter the same as an outer diameter of the valve discs 154 to 156. The valve discs 157 are bendable.

The disc 158 has an outer diameter smaller than an outer diameter of the valve discs 154 to 157.

The disc 159 has an outer diameter larger than the outer diameter of the disc 158 and slightly smaller than the outer diameter of the valve discs 154 to 157.

When the body valve 30 is assembled, the disc 159, the disc 158, the plurality of valve discs 157, the valve disc 156, the valve disc 155, the valve disc 154, the disc spring 153, the opening/closing disc 152, the disc 151, the valve base 25, and the valve disc 110, the valve disc 111, the disc 112, the spring disc 113, and restriction disc 114 shown in FIG. 2 are stacked on the head part 102 of the pin member 101 in that order with the shaft part 103 of the pin member 101 fitted inside each of them.

At that time, the disc spring 153 shown in FIG. 3 is directed such that the corner portion 164 is positioned on a side opposite to the valve disc 154. Also, at that time, the valve base 25 is directed such that the inner seat 84 is in contact with the disc 151. Also, at that time, the spring disc 113 shown in FIG. 2 is directed such that the spring plate part 132 is in contact with the valve disc 111. Also, at that time, the restriction disc 114 is directed such that the outer circumferential stepped part 142 protrudes from the main plate part 141 to the valve disc 111 side in the axial direction.

In this state, a nut 201 is screwed to the male screw 104 of the pin member 101 which protrudes from the main plate part 141 of the restriction disc 114. Thereby, the disc 159, the disc 158, the plurality of valve discs 157, the valve disc 156, the valve disc 155, the valve disc 154, the disc spring 153, the opening/closing disc 152, the disc 151, and the valve base 25 shown in FIG. 3, and the valve disc 110, the valve disc 111, the disc 112, the spring disc 113, and restriction disc 114 shown in FIG. 2 are clamped by the head part 102 and the nut 201 of the pin member 101 at least at their inner circumferential sides.

In a state of being incorporated in the body valve 30, as shown in FIG. 3, the disc spring 153 has a portion of the base plate part 161 on an inner circumferential side having a flat plate shape, and a portion of the base plate part 161 on an outer circumferential side deformed into a tapered shape such that it becomes further away from the valve disc 154 in an axial direction toward the radially outer side. Also, in this state, the disc spring 153 forms a tapered shape so that the outer circumferential tapered plate part 162 approaches the valve disc 154 in the axial direction toward the radially outer side, and comes into contact with the valve disc 154 at a distal end portion thereof. At that time, the outer circumferential tapered plate part 162 of the disc spring 153 comes into contact with an annular portion of the valve disc 154 between the notch 171 and the passage hole 172 in the radial direction over the entire circumference. Therefore, the disc spring 153 is provided to cover the passage hole 172 of the valve disc 154. Also, in this state, the entire passage hole 163 of the disc spring 153 overlaps the passage hole 172 of the valve disc 154 in a radial position.

In a state of being incorporated in the body valve 30, the opening/closing disc 152 has a flat plate shape at a portion on an inner circumferential side. Also, in this state, the opening/closing disc 152 is pressed by the portion on the outer circumferential side of the base plate part 161 of the disc spring 153 at a portion on an outer circumferential side, and deforms into a tapered shape such that it becomes further away from the valve disc 154 in the axial direction toward the outer side in the radial direction. Thereby, the opening/closing disc 152 is in surface contact with the base plate part 161 of the disc spring 153 by an elastic force thereof. As a result, the opening/closing disc 152 covers the entirety of the plurality of passage holes 163 of the disc spring 153 to close the plurality of passage holes 163.

The assembled body valve 30 assembled as described above is placed on the bottom part 21 of the outer cylinder 16 with the small diameter part 32 thereof fitted in one end of the inner cylinder 15 in the axial direction as shown in FIG. 2. As a result, the body valve 30 is in a state of communicating with the cylinder 17.

In the body valve 30, a space between the intermediate seat 87 and the outer seat 86 of the valve base 25 and the inside of the plurality of outer passage holes 91 serve as a first passage 211 that allows communication between the reservoir chamber 18 and the second chamber 49. Also, in the body valve 30, the valve discs 110 and 111, the disc 112, and the spring disc 113 serve as a first damping valve 212 that opens and closes the first passage 211. A flow of the oil fluid L, which serves as a working fluid, occurs in the first passage 211 due to movement in an extension direction, which is one direction, of the piston 45 shown in FIG. 1. The first damping valve 212 shown in FIG. 2 provides resistance to a flow of the oil fluid L from the reservoir chamber 18 on an upstream side to the second chamber 49 on a downstream side of the first passage 211. The first damping valve 212 and the orifice 123 are provided in the first passage 211 and constitute a first damping force generation mechanism 215 on the extension side that suppresses a flow of the oil fluid L flowing inside the first passage 211 to generate a damping force.

In the body valve 30, the orifice 128 provided in the first damping valve 212, a space between the base main body part 82, the inner seat 83, and the intermediate seat 87 of the valve base 25, and the inside of the plurality of inner passage holes 92 serve as a second passage 221. The second passage 221 includes a variable chamber 220 surrounded by the base main body part 82, the inner seat 84, the outer seat 88, and the plurality of protruding parts 89 of the valve base 25 shown in FIG. 3, the disc 151, the opening/closing disc 152, the disc spring 153 and the valve disc 154. The second passage 221 allows communication between the second chamber 49 and the reservoir chamber 18 shown in FIG. 2.

In the body valve 30, the valve discs 154 to 157 shown in FIG. 3 serve as a second damping disc valve 222 which opens and closes the second passage 221 by being separated from and coming into contact with the outer seat 88. Therefore, the second damping disc valve 222 is provided in the body valve 30. A flow of the oil fluid L, which serves as a working fluid, occurs in the second passage 221 due to movement in a compression direction, which is the other direction, of the piston 45 shown in FIG. 1. The second damping disc valve 222 shown in FIG. 2 provides resistance to a flow of the oil fluid L from the second chamber 49 on an upstream side to the reservoir chamber 18 on a downstream side of the second passage 221.

In the body valve 30, the inside of the notch 171 of the valve disc 154 of the second damping disc valve 222 shown in FIG. 3 serves as a third passage 231. The third passage 231 is an orifice that allows constant communication between the variable chamber 220 and the reservoir chamber 18. The third passage 231 is provided in the second passage 221. The second passage 221 allows constant communication between the reservoir chamber 18 and the second chamber 49 shown in FIG. 2 through the third passage 231. In other words, the third passage 231 allows constant communication between the reservoir chamber 18 on the upstream side and the second chamber 49 on the downstream side when the piston 45 shown in FIG. 1 moves in the extension direction, and allows constant communication between the second chamber 49 on the upstream side and the reservoir chamber 18 on the downstream side when the piston 45 moves in the compression direction. The second damping disc valve 222 and the third passage 231, which is an orifice, shown in FIG. 3 are provided in the second passage 221 and constitute a second damping force generation mechanism 225 on the compression side which suppresses a flow of the oil fluid L flowing inside the second passage 221 to generate a damping force.

In the body valve 30, the inside of the notch 191 and passage hole 192 of the valve disc 156, the inside of the passage hole 181 of the valve disc 155, and the inside of the passage hole 172 of the valve disc 154 in the second damping disc valve 222 serve as a fourth passage 241 (communication passage) that is in constant communication with the reservoir chamber 18 on the upstream side when the piston 45 shown in FIG. 1 moves in the extension direction. In other words, the second damping disc valve 222 has the fourth passage 241. Further, a part of the fourth passage 241 may be provided in the pin member 101.

The fourth passage 241 has an orifice 242 inside the notch 191 of the valve disc 156. In the fourth passage 241, the inside of the passage hole 192 of the valve disc 156, the inside of the passage hole 181 of the valve disc 155, and the inside of the passage hole 172 of the valve disc 154 form an intermediate chamber 243.

The third passage 231 and the fourth passage 241 are provided in the second damping disc valve 222. The third passage 231 and a part of the fourth passage 241 are formed in the valve disc 154 of the second damping disc valve 222 seated on the outer seat 88.

In the body valve 30, the base main body part 82, the inner seat 84, the outer seat 88, and the plurality of protruding parts 89 of the valve base 25, the disc 151, the opening/closing disc 152, the disc spring 153, and the valve disc 154 constitute a pressure accumulation mechanism 251 including the variable chamber 220.

A portion of the pressure accumulation mechanism 251 surrounded by the opening/closing disc 152, the disc spring 153, and the valve disc 154 is a variable chamber 252. In other words, the pressure accumulation mechanism 251 has a variable chamber 252. The variable chamber 252 is partitioned from the variable chamber 220 of the second passage 221 by the disc spring 153 and the opening/closing disc 152. The disc spring 153 and the opening/closing disc 152 constitute a partition member 255 that partitions the variable chamber 252 and the variable chamber 220. The variable chamber 252 communicates with the fourth passage 241.

The partition member 255 is movable according to a change in pressure of the reservoir chamber 18 on the upstream side or the second chamber 49 on the downstream side when the piston 45 shown in FIG. 1 moves in the extension direction. The partition member 255 shown in FIG. 3 is movable according to a change in pressure of the second chamber 49 on the upstream side or the reservoir chamber 18 on the downstream side when the piston 45 shown in FIG. 1 moves in the compression direction. The partition member 255 shown in FIG. 3 is constituted by the disc spring 153. The partition member 255 increases the variable chamber 252 formed between itself and the valve disc 154 shown in FIG. 3 and decreases the variable chamber 220 during the extension stroke of the piston 45 shown in FIG. 1 while increasing the variable chamber 220 shown in FIG. 3 and decreasing the variable chamber 252 during the compression stroke of the piston 45 shown in FIG. 1.

When the disc spring 153 deforms in a direction that increases the variable chamber 252 and reaches a predetermined amount of deformation, it comes into contact with the protruding part 89 of the valve base 25 with the corner portion 164, and any further deformation is curbed. When the disc spring 153 deforms in a direction that increases the variable chamber 220 and reaches a predetermined amount of deformation, any further deformation is curbed by the valve disc 154. In the disc spring 153, the outer circumferential tapered plate part 162 is in constant contact with the valve disc 154 over the entire circumference, and seals between the variable chamber 252 and the variable chamber 220. Here, since the protruding part 89 is formed intermittently in a circumferential direction of the valve base 25, the second passage 221 is not closed even if the disc spring 153 comes into contact with the protruding part 89 with the corner portion 164.

In the partition member 255, when a differential pressure between the variable chamber 252 shown in FIG. 3 on an upstream side and the variable chamber 220 on a downstream side reaches a predetermined value during movement of the piston 45 shown in FIG. 1 in the extension direction, the opening/closing disc 152 separates from the disc spring 153 and opens the passage hole 163 of the disc spring 153 to allow the variable chamber 252 to communicate with the variable chamber 220, that is, the second chamber 49 shown in FIG. 2. The passage hole 163 of the disc spring 153 and the opening/closing disc 152 shown in FIG. 3 constitute a relief mechanism 258 that relieves the inside of the variable chamber 252 after the differential pressure between the variable chamber 252 shown in FIG. 3 on the upstream side and the variable chamber 220 on the downstream side during movement of the piston 45 shown in FIG. 1 in the extension direction reaches the predetermined value. In other words, the partition member 255 includes the relief mechanism 258.

The pressure accumulation mechanism 251 includes the variable chamber 252 that communicates with the fourth passage 241. The variable chamber 252 is partitioned from the variable chamber 220 of the second passage 221 by the partition member 255 shown in FIG. 3 that is movable according to a change in pressure of the reservoir chamber 18 on the upstream side or the second chamber 49 on the downstream side when the piston 45 shown in FIG. 1 moves in the extension direction.

The variable chambers 220 and 252 are formed by the second damping disc valve 222. The variable chambers 220 and 252 are disposed to overlap the second damping disc valve 222 in an axial direction of the second damping disc valve 222. The pressure accumulation mechanism 251 including the variable chambers 220 and 252 is disposed to overlap the second damping disc valve 222 in the axial direction of the second damping disc valve 222.

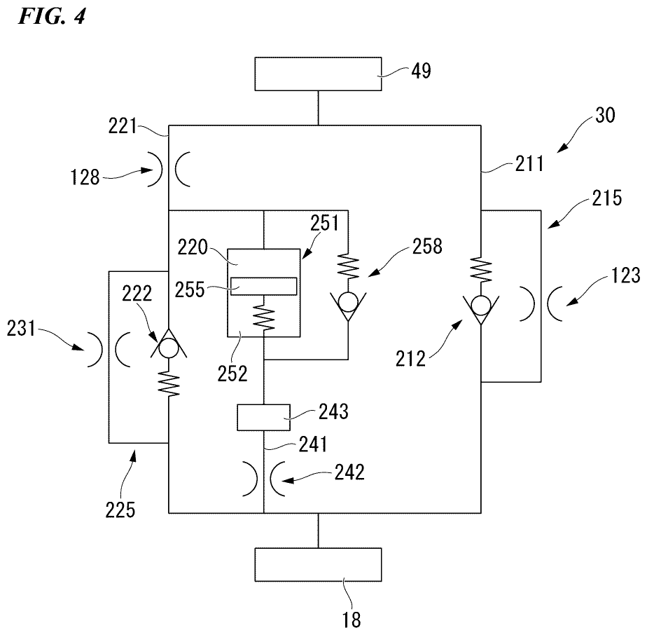

A hydraulic circuit diagram of the body valve 30 described above is shown in FIG. 4.

In the body valve 30, the first damping force generation mechanism 215 on the extension side including the first damping valve 212 and the orifice 123 is provided in the first passage 211 on the extension side that allows communication between the reservoir chamber 18 and the second chamber 49. Also, in the body valve 30, the second damping force generation mechanism 225 on the compression side including the orifice 128, the second damping disc valve 222, and the third passage 231 is provided in the second passage 221 that allows communication between the second chamber 49 and the reservoir chamber 18. Also, in the body valve 30, the variable chamber 220 of the pressure accumulation mechanism 251 is provided between the orifice 128 and the second damping force generation mechanism 225 of the second passage 221. Also, in the body valve 30, the variable chamber 252 of the pressure accumulation mechanism 251 communicates with the reservoir chamber 18 via the intermediate chamber 243 and the orifice 242 of the fourth passage 241. Also, in the body valve 30, the relief mechanism 258 restricting a flow of the oil fluid L from the variable chamber 220 to the variable chamber 252 and allowing a flow of the oil fluid L from the variable chamber 252 to the variable chamber 220 is provided between the variable chamber 252 and the variable chamber 220 of the pressure accumulation mechanism 251.

Next, main operations of the body valve 30 will be described.

During the extension stroke in which the piston rod 50 moves to the extension side, if only the first damping force generation mechanism 215 on the extension side acts, in a low speed region in which a moving speed of the piston 45 (hereinafter referred to as a piston speed) is lower than a predetermined value, the oil fluid L from the reservoir chamber 18 flows into the second chamber 49 mainly via the orifice 123 of the first passage 211 on the extension side. Therefore, a damping force having orifice characteristics (in which the damping force is substantially proportional to the square of the piston speed) is generated. Damping force characteristics with respect to the piston speed when the piston speed is in the low speed region, an increasing rate of the damping force is relatively high with respect to an increase in the piston speed.

Also, during the extension stroke, in a high speed region in which the piston speed is equal to or higher than the predetermined value, the oil fluid L from the reservoir chamber 18 opens the first damping valve 212 of the first passage 211 on the extension side to flow into the second chamber 49. Therefore, a damping force having valve characteristics (in which the damping force is substantially proportional to the piston speed) is generated. Therefore, damping force characteristic with respect to the piston speed when the piston speed is in a high speed region is such that an increasing rate of the damping force with respect to an increase in the piston speed is slightly lower than that in the low speed region described above.

During the compression stroke in which the piston rod 50 moves to the compression side, if only the second damping force generation mechanism 225 on the compression side acts, in a low speed region in which the piston speed is lower than a predetermined value, the oil fluid L from the second chamber 49 flows into the reservoir chamber 18 mainly via the third passage 231, which is an orifice, of the second passage 221. Therefore, a damping force having orifice characteristics (in which the damping force is substantially proportional to the square of the piston speed) is generated. Therefore, damping force characteristics with respect to the piston speed when the piston speed is in the low speed region, an increasing rate of the damping force is relatively high with respect to an increase in the piston speed.

Also, during the compression stroke, in a high speed region in which the piston speed is equal to or higher than the predetermined value, the oil fluid L from the second chamber 49 opens the second damping disc valve 222 of the second passage 221 to flow into the reservoir chamber 18. Therefore, a damping force having valve characteristics (in which the damping force is substantially proportional to the piston speed) is generated. Therefore, damping force characteristic with respect to the piston speed when the piston speed is in a high speed region is such that an increasing rate of the damping force with respect to an increase in the piston speed is slightly lower than that in the low speed region described above.

The description above is a case in which only the first damping force generation mechanism 215 and the second damping force generation mechanism 225 act, but in the first embodiment, the pressure accumulation mechanism 251 varies the damping force according to a piston frequency even if the piston speed is the same during the extension stroke and the compression stroke described above.

That is, during the extension stroke, a pressure in the second chamber 49 becomes lower than a pressure in the reservoir chamber 18, and the oil fluid L in the reservoir chamber 18 is introduced into the first passage 211 and flows into the second chamber 49 via the first damping force generation mechanism 215. In addition to this, the oil fluid L in the reservoir chamber 18 is introduced from the fourth passage 241 into the variable chamber 252 of the pressure accumulation mechanism 251 and deforms the partition member 255 to expand the variable chamber 252. At that time, the oil fluid L in the variable chamber 220 that is reduced in size is discharged to the second chamber 49 through the second passage 221.

During the extension stroke at a low speed in which the piston speed is lower than a predetermined value and at a low frequency in which the piston frequency is lower than a predetermined value, since a stroke of the piston 45 is large, at the beginning of the introduction of the oil fluid L from the reservoir chamber 18 to the variable chamber 252 through the fourth passage 241, the partition member 255 is largely bent, the disc spring 153 comes into contact with the protruding part 89 of the valve base 25 with the corner portion 164, and thereby any further deformation is curbed. Thereby, the variable chamber 252 is placed in a state in which an increase in volume is suppressed, and the variable chamber 252 can no longer absorb an increase in the oil fluid L being introduced. Then, a force of the oil fluid L in the reservoir chamber 18 pushing the first damping valve 212 in an opening direction becomes higher. Therefore, the first damping valve 212 opens to allow the oil fluid L to flow into the second chamber 49 through the first passage 211. Therefore, during the extension stroke at a low speed in which the piston speed is lower than the predetermined value and at a low frequency in which the piston frequency is lower than the predetermined value, the damping force characteristics are the same as in a case in which the pressure accumulation mechanism 251 is not provided.

On the other hand, even at a low speed in which the piston speed is lower than the predetermined value, during the extension stroke at a high frequency in which the piston frequency is equal to or higher than the predetermined value, since the stroke of the piston 45 is small, a volume of the oil fluid L introduced into the variable chamber 252 from the reservoir chamber 18 through the fourth passage 241 is small. Therefore, the partition member 255 also has a small amount of bending, and does not come into contact with the protruding part 89 of the valve base 25, or is deformable even if it does come into contact with it. Therefore, most of the increase in the oil fluid L introduced into the variable chamber 252 from the reservoir chamber 18 through the fourth passage 241 is absorbed by the bending of the partition member 255. Then, the force of the oil fluid L in the reservoir chamber 18 pushing the first damping valve 212 in the opening direction is further suppressed than that at the low frequency in which the piston frequency is lower than the predetermined value, and the damping force becomes lower and softer than that at the low frequency.

Therefore, during the extension stroke, at a low speed in which the piston speed is lower than the predetermined value, the damping force characteristics at a high frequency in which the piston frequency is equal to or higher than the predetermined value become a state in which the damping force is lower and softer compared to the damping force characteristics at a low frequency in which the piston frequency is lower than the predetermined value. Thereby, during the extension stroke at a low speed in which the piston speed is lower than the predetermined value and at a high frequency in which the piston frequency is equal to or higher than the predetermined value, which is when abnormal noise is likely to occur, a sudden change in hydraulic pressure when the first damping valve 212 opens is suppressed, making it possible to reduce an acceleration of the piston rod 50 (hereinafter referred to as a rod acceleration) and suppress occurrence of abnormal noise.

Also, at a high speed in which the piston speed is equal to or higher than the predetermined value, the opening/closing disc 152 deforms and separates from the disc spring 153 in a state in which the partition member 255 is largely bent, the disc spring 153 comes into contact with the protruding part 89 of the valve base 25 with the corner portion 164, and any further deformation is curbed. In other words, the relief mechanism 258 opens. Thereby, the oil fluid L in the variable chamber 252 is allowed to flow into the second chamber 49 through the second passage 221 including the variable chamber 220. With such a relief function, a pressure load on the disc spring 153 can be alleviated and durability can be secured. At the same time, since an amount of movement of the oil fluid L to the second chamber 49 during the extension stroke can be increased, excessive pressure reduction in the second chamber 49 can be suppressed, and cavitation can be curbed.

In the compression stroke, a pressure in the second chamber 49 becomes higher than a pressure in the reservoir chamber 18, and the oil fluid L in the second chamber 49 is introduced into the second passage 221 and flows into the reservoir chamber 18 via the second damping force generation mechanism 225. In addition to this, the oil fluid L in the second chamber 49 is introduced into the variable chamber 220 of the pressure accumulation mechanism 251 and deforms the partition member 255 to expand the variable chamber 220. At that time, the oil fluid L in the variable chamber 252 that is reduced in size is discharged into the reservoir chamber 18 through the fourth passage 241.

During the compression stroke in which the piston frequency is lower than the predetermined value, since the stroke of the piston 45 is large, at the beginning of the introduction of the oil fluid L from the second chamber 49 into the variable chamber 220, the partition member 255 is largely bent and deformation is suppressed by the valve disc 154. Thereby, a volume of the variable chamber 220 remains unchanged, and the variable chamber 220 is no longer able to absorb the increase in the oil fluid L being introduced. Then, a pressure in the variable chamber 220 increases to a high pressure, and thus a force pushing the second damping disc valve 222 in the opening direction becomes higher. Therefore, the second damping disc valve 222 opens and allows the oil fluid L to flow into the reservoir chamber 18 through a gap between itself and the outer seat 88. Therefore, during the compression stroke at a low frequency in which the piston frequency is lower than the predetermined value, damping force characteristics are the same as in a case in which the pressure accumulation mechanism 251 is not provided.

On the other hand, during the compression stroke in which the piston frequency is equal to or higher than the predetermined value, since the stroke of the piston 45 is small, and a volume of the oil fluid L introduced from the second chamber 49 into the variable chamber 220 is small, the partition member 255 also has a small amount of bending and is likely to be deformed. Therefore, most of the increase in the oil fluid L introduced from the second chamber 49 into the variable chamber 220 is absorbed by the bending of the partition member 255. Therefore, the pressure in the variable chamber 220 is low, and an opening pressure of the second damping disc valve 222 does not increase. Therefore, when the piston frequency is high, the damping force becomes lower and softer than when the piston frequency is low.

Therefore, during the compression stroke, the damping force characteristics when the piston frequency is a high frequency equal to or higher than the predetermined value become a state in which the damping force is lower and softer compared to the damping force characteristics at a low frequency in which the piston frequency is lower than the predetermined value. Thereby, during the compression stroke at a high frequency in which the piston frequency is equal to or higher than the predetermined value, which is when abnormal noise is likely to occur, a sudden change in hydraulic pressure when the second damping disc valve 222 opens is suppressed, making it possible to reduce the rod acceleration and suppress occurrence of abnormal noise.

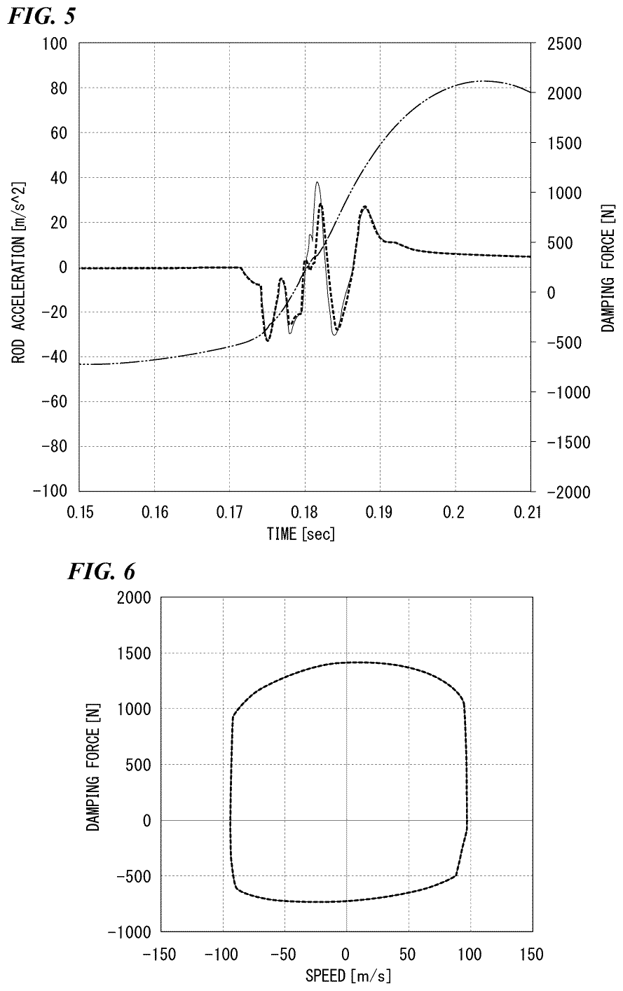

The broken line in FIG. 5 shows a simulation result of the rod acceleration of the shock absorber 11 of the first embodiment which includes the body valve 30 having the pressure accumulation mechanism 251. The solid line in FIG. 5 shows a simulation result of a rod acceleration of a shock absorber which includes a body valve of a comparative example having a conventional structure which differs from the body valve 30 in that the pressure accumulation mechanism 251 and the fourth passage 241 are not provided. The two-dot chain line in FIG. 5 shows a simulation result of the damping force. From FIG. 5, it can be seen that a peak value of the rod acceleration caused by opening of the first damping valve 212 decreases in the shock absorber 11 of the first embodiment compared to that in the shock absorber of the comparative example described above.

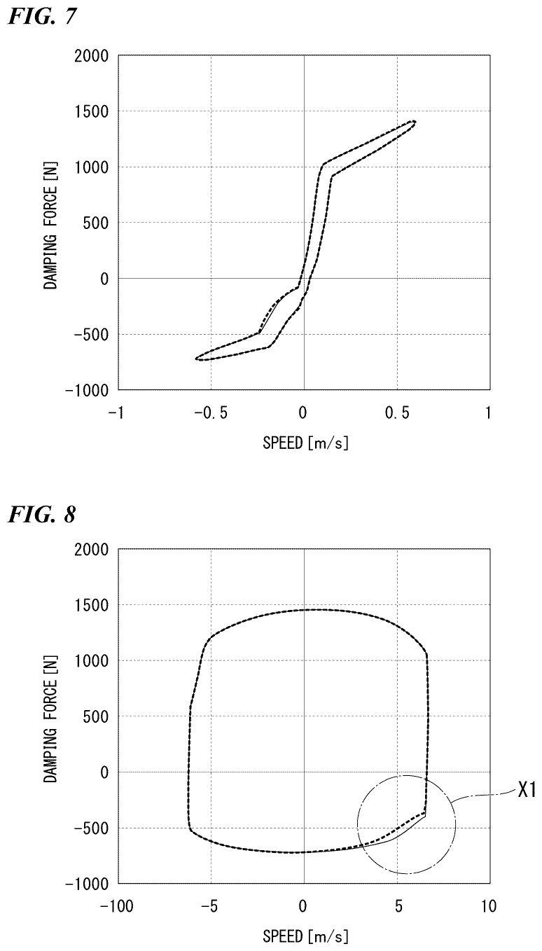

The broken lines in FIGS. 6 and 7 show simulation results of the damping force of the standalone shock absorber 11 of the first embodiment at a piston speed of 0.6 m/s and under a low-frequency input. The solid lines in FIGS. 6 and 7 show simulation results of the damping force of the standalone shock absorber of the comparative example described above at a piston speed of 0.6 m/s and under a low-frequency input.

From FIGS. 6 and 7, it can be seen that the shock absorber 11 of the first embodiment can maintain almost the same damping force waveform as the shock absorber of the comparative example when the piston frequency is low, and maintain equivalent performance.

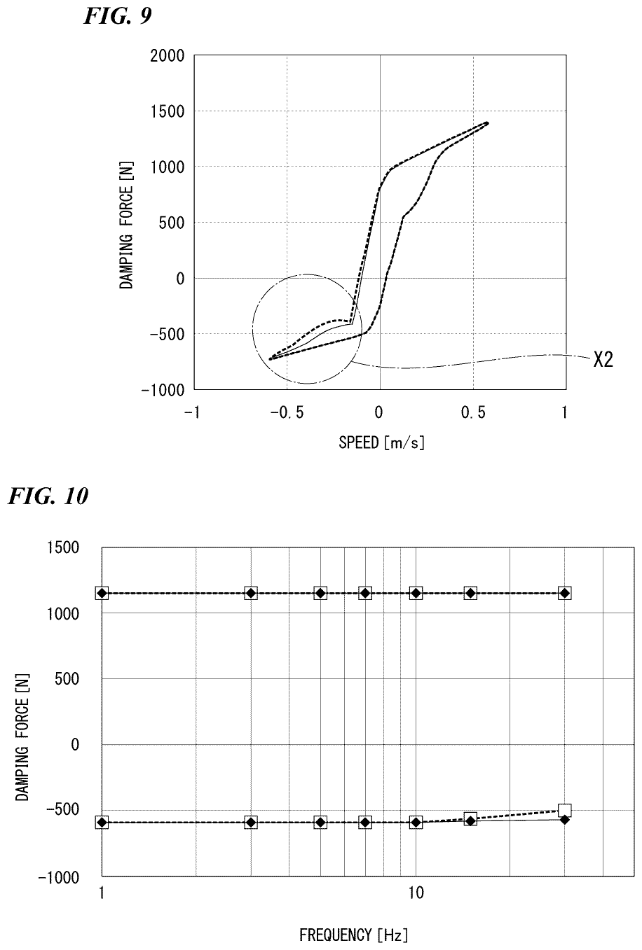

The broken lines in FIGS. 8 and 9 show simulation results of the damping force of the standalone shock absorber 11 of the first embodiment at a piston speed of 0.6 m/s and under a high-frequency input. The solid lines in FIGS. 8 and 9 show simulation results of the damping force of the standalone shock absorber of the comparative example described above at a piston speed of 0.6 m/s and under a high-frequency input.

From FIGS. 8 and 9, it can be seen that, when the piston frequency is high, the extension-side damping force of the first damping valve 212 of the body valve 30 of the shock absorber 11 of the first embodiment is almost unchanged compared to that in the shock absorber of the comparative example. This is because the first damping valve 212 of the body valve 30 has a lower differential pressure than the extension-side disc valve 58 of the piston 45. Also, in the shock absorber 11 of the first embodiment, when the piston frequency is high, the second damping disc valve 222 of the body valve 30, which has a large contribution to the compression-side damping force, has a slightly lower damping force after opening, but the peak value remains the same as that of the shock absorber of the comparative example described above as shown in the range surrounded by the dashed dotted line X1 in FIG. 8 and the range surrounded by the dashed dotted line X2 in FIG. 9.

The broken line in FIG. 10 shows frequency characteristics of the damping force when the piston speed of the shock absorber 11 of the first embodiment is 0.3 m/s. The solid line in FIG. 10 shows frequency characteristics of the damping force when the piston speed of the shock absorber of the comparative example described above is 0.3 m/s. From FIG. 10, regarding frequency dependency, it can be seen that, in the shock absorber 11 of the first embodiment in which the pressure accumulation mechanism 251 is provided, the compression-side damping force is slightly reduced when the piston frequency is high, but the performance can be maintained almost the same as that of the shock absorber of the comparative example described above that does not have a pressure accumulation mechanism. The shock absorber 11 of the first embodiment can improve quietness (hitting noise and vibration) and harshness while firmly maintaining basic performance of the conventional shock absorber that does not have a pressure accumulation mechanism. The shock absorber 11 has an effect of improving smoothness in ride comfort by reducing the high-frequency input of the piston frequency.

The Patent Documents 1 and 2 described above disclose a shock absorber having a body valve. Incidentally, there has been a demand to suppress occurrence of abnormal noise in a shock absorber.

In the shock absorber 11 of the first embodiment, the body valve thereof includes the first passage 211 through which a flow of the oil fluid L occurs due to movement of the piston 45 in one direction, the first damping valve 212 providing resistance to a flow of the oil fluid L from the reservoir chamber 18 on the upstream side to the second chamber 49 on the downstream side of the first passage 211, the second passage 221 through which a flow of the oil fluid L occurs due to movement of the piston 45 in the other direction, and the second damping disc valve 222 providing resistance to a flow of the oil fluid L from the second chamber 49 on the upstream side to the reservoir chamber 18 on the downstream side of the second passage 221. Then, in the body valve 30, the second damping disc valve 222 includes the third passage 231 allowing constant communication between the reservoir chamber 18 on the upstream side and the second chamber 49 on the downstream side, and the fourth passage 241 communicating with the reservoir chamber 18 on the upstream side. Therefore, in the body valve 30 of the shock absorber 11, the oil fluid L can be introduced from the reservoir chamber 18 into the variable chamber 252 when the first damping valve 212 opens during the extension stroke in which the piston frequency is high, which is when abnormal noise is significantly noticeable. Therefore, during the extension stroke in which the piston frequency is high, which is when abnormal noise is significantly noticeable, the body valve 30 of the shock absorber 11 can suppress a sudden change in hydraulic pressure when the first damping valve 212 opens and reduce the rod acceleration, and therefore occurrence of abnormal noise can be suppressed. As a result, it is possible to achieve both suppression of abnormal noise and securement of a damping force from a very low piston speed.

In the body valve 30 of the shock absorber 11 of the first embodiment, the variable chamber 252 communicating with the fourth passage 241 and partitioned by the partition member 255, which is movable according to a change in pressure of the reservoir chamber 18 on the upstream side or the second chamber 49 on the downstream side, is disposed to overlap the second damping disc valve 222. In other words, the pressure accumulation mechanism 251 including the variable chamber 252 is disposed to overlap the second damping disc valve 222. Therefore, the shock absorber 11 can be made compact in configuration.

In the shock absorber 11 of the first embodiment, the third passage 231 and the fourth passage 241 are formed in the valve disc 154 of the second damping disc valve 222 seated on the outer seat 88. Therefore, the shock absorber 11 can be made more compact in configuration.

Since the partition member 255 is constituted by the disc spring 153 which increases the variable chamber 252 formed between itself and the valve disc 154 during the extension stroke of the piston 45 and decreases the variable chamber 252 during the compression stroke, the shock absorber 11 of the first embodiment can be made compact and suppress an increase in cost.

In the shock absorber 11 of the first embodiment, since the partition member 255 includes the relief mechanism 258 that relieves the inside of the variable chamber 252 after a differential pressure between the variable chamber 252 on the upstream side and the variable chamber 220 on the downstream side in the extension stroke of the piston 45 reaches the predetermined value, excessive deformation of the disc spring 153 can be suppressed, and durability of the disc spring 153 can be enhanced. Also, since an amount of movement of the oil fluid L from the reservoir chamber 18 to the second chamber 49 can be increased by the relief mechanism 258 during the extension stroke, the shock absorber 11 can make up for a lack of the flow rate due to the first damping valve 212 in a high piston speed region. Therefore, the shock absorber 11 can suppress excessive pressure reduction in the second chamber 49 and curb cavitation. Also, since the relief mechanism 258 is provided in the partition member 255, the shock absorber 11 can be made more compact in configuration.

In the shock absorber 11 of the first embodiment, since the second damping disc valve 222 is provided in the body valve 30, abnormal noise caused by an operation of the body valve 30 can be effectively suppressed. Also, since a compact configuration can be made even if the pressure accumulation mechanism 251 is provided in the body valve 30, a stroke length of the piston rod 50 is not sacrificed.

Since the shock absorber 11 of the first embodiment includes the pressure accumulation mechanism 251 provided between the valve base 25 having the outer seat 88 of the body valve 30 and the second damping disc valve 222 which opens and closes the outer seat 88, an increase in axial length of the body valve 30 can be further suppressed.

### Second Embodiment

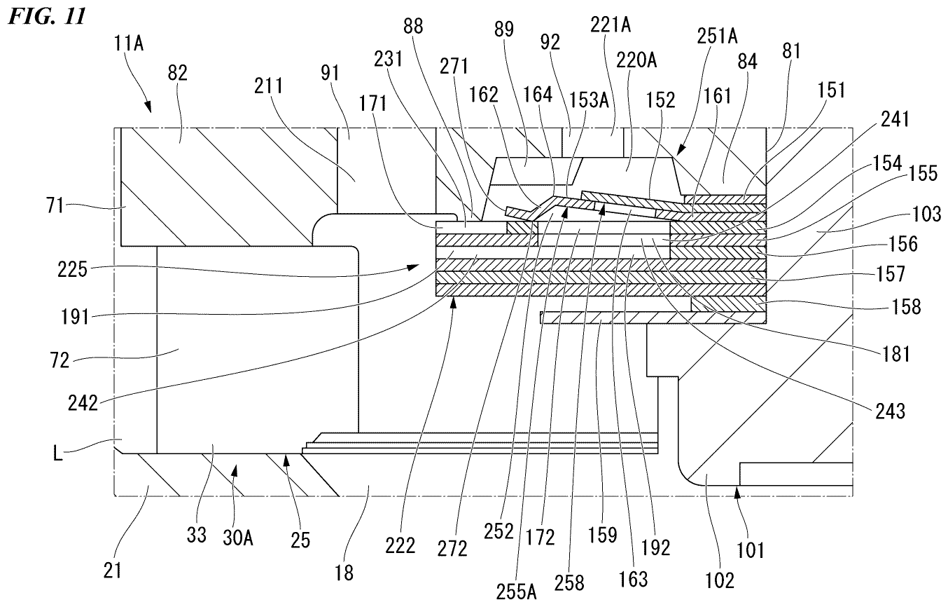

Next, a second embodiment will be described mainly on the basis of FIG. 11, focusing on differences from the first embodiment. Further, parts common to those in the first embodiment will be denoted by the same terms and the same reference signs.

As shown in FIG. 11, a shock absorber 11A of the second embodiment includes a body valve 30A, which is partially different from the body valve 30, instead of the body valve 30.

The body valve 30A includes a pressure accumulation mechanism 251A, which is partially different from the pressure accumulation mechanism 251, instead of the pressure accumulation mechanism 251. The pressure accumulation mechanism 251A includes a partition member 255A, which is partially different from the partition member 255, instead of the partition member 255. The partition member 255A includes a disc spring 153A, which is partially different from the disc spring 153, instead of the disc spring 153.

The disc spring 153A is also formed by press-forming one plate material having a flat plate shape. The disc spring 153A includes an outermost circumferential plate part 271 in addition to a base plate part 161 and an outer circumferential tapered plate part 162 similar to those of the disc spring 153. The outermost circumferential plate part 271 extends outward in a radial direction from an outer circumferential edge portion of the outer circumferential tapered plate part 162. The outermost circumferential plate part 271 has an annular shape and is formed over the entire circumference of the outer circumferential tapered plate part 162.

The disc spring 153A has a curved part 272 between the outer circumferential tapered plate part 162 and the outermost circumferential plate part 271. The curved part 272 is provided over the entire circumference of the disc spring 153A and has a circular shape.

In a state of being incorporated in the body valve 30A, the disc spring 153A has a portion of the base plate part 161 on an inner circumferential side having a flat plate shape, and a portion of the base plate part 161 on an outer circumferential side deformed into a tapered shape such that it becomes further away from a valve disc 154 in an axial direction toward the outer side in the radial direction. Also, in this state, the disc spring 153A forms a tapered shape so that the outer circumferential tapered plate part 162 approaches the valve disc 154 in the axial direction toward the outer side in the radial direction, and extends to the valve disc 154 side. Also, in this state, the curved part 272 of the disc spring 153A comes into contact with an annular portion of the valve disc 154 between a notch 171 and a passage hole 172 in a radial direction over the entire circumference. Also, in this state, the disc spring 153A extends in a tapered shape so that the outermost circumferential plate part 271 becomes further away from the valve disc 154 in the axial direction toward the outer side in the radial direction.

The body valve 30A has a second passage 221A, which is partially different from the second passage 221, instead of the second passage 221. The second passage 221A has a variable chamber 220A, which is partially different from the variable chamber 220, instead of the variable chamber 220. The variable chamber 220A is formed to be surrounded by a base main body part 82, an inner seat 84, an outer seat 88, and a plurality of protruding parts 89 of a valve base 25, a disc 151, the partition member 255A, and the valve disc 154.

A hydraulic circuit diagram of the body valve 30A is similar to that of the body valve 30.

In the shock absorber 11A of the second embodiment, the body valve 30A operates in the same manner as the body valve 30.

The shock absorber 11A of the second embodiment and the body valve 30A thereof achieve the same effects as in the first embodiment. In addition, in the shock absorber 11A, the disc spring 153A of the body valve 30A is in constant contact with an annular portion of the valve disc 154 between the notch 171 and the passage hole 172 in the radial direction over the entire circumference at a curved surface formed by bending the curved part 272. As described above, since the disc spring 153A is in contact with the valve disc 154 at the curved surface of the curved part 272, a sealing property of the disc spring 153A at the contact portion with the valve disc 154 can be improved compared to that of the disc spring 153 which is in contact with the valve disc 154 at an edge portion of a distal end of the outer circumferential tapered plate part 162.

### Third Embodiment

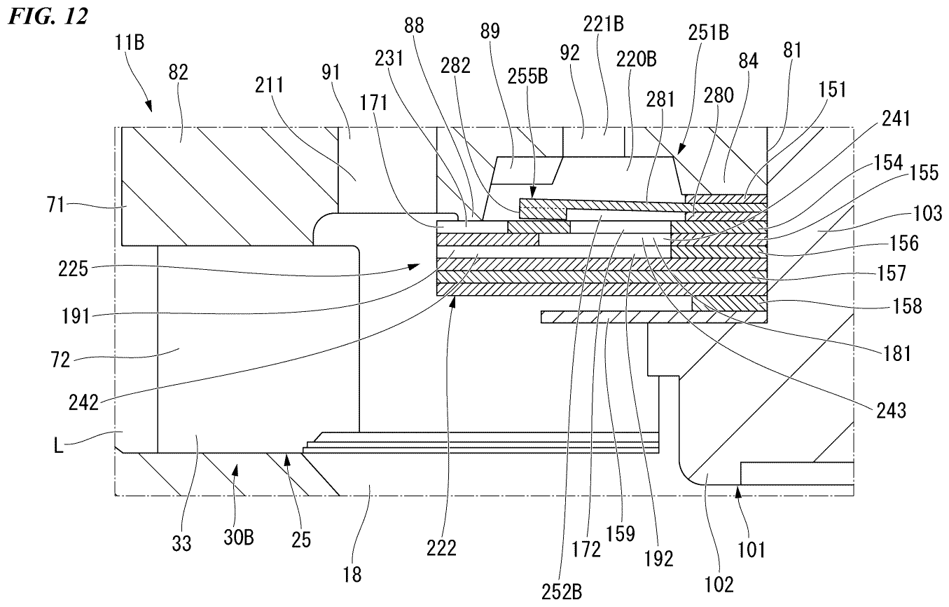

Next, a third embodiment will be described mainly on the basis of FIGS. 12 to 14, focusing on differences from the first embodiment. Further, parts common to those in the first embodiment will be denoted by the same terms and the same reference signs.

As shown in FIG. 12, a shock absorber 11B of the third embodiment includes a body valve 30B, which is partially different from the body valve 30, instead of the body valve 30. The body valve 30B includes a pressure accumulation mechanism 251B, which is partially different from the pressure accumulation mechanism 251, instead of the pressure accumulation mechanism 251. The pressure accumulation mechanism 251B includes a partition member 255B, which is different from the partition member 255, instead of the partition member 255. The pressure accumulation mechanism 251B includes a disc 280 similar to a disc 151.

A shaft part 103 of a pin member 101 can be fitted inside the partition member 255B. The partition member 255B includes a base plate disc 281 and an outer circumferential disc 282.

Both the base plate disc 281 and the outer circumferential disc 282 are made of a metal.

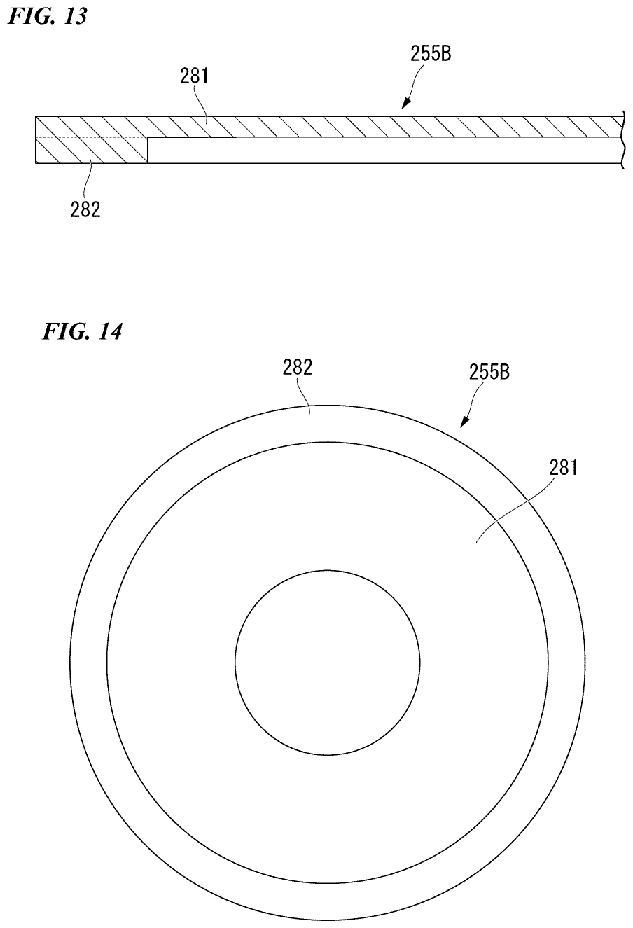

The base plate disc 281 of the partition member 255B has a perforated disc shape with a constant thickness in a natural state before being incorporated into the body valve 30B as shown in FIGS. 13 and 14. Also, the outer circumferential disc 282 of the partition member 255B has a perforated disc shape with a constant thickness in a natural state before being incorporated into the body valve 30B. In a natural state before the partition member 255B is incorporated into the body valve 30B, an outer diameter of the outer circumferential disc 282 is the same as an outer diameter of the base plate disc 281, and an inner diameter of the outer circumferential disc 282 is larger than an inner diameter of the base plate disc 281. The outer circumferential disc 282 is coaxial with the base plate disc 281 and is fixed to one side of the base plate disc 281 in an axial direction by welding.

When the body valve 30B is assembled, a disc 159, a disc 158, a plurality of valve discs 157, a valve disc 156, a valve disc 155, a valve disc 154, the disc 280, the partition member 255B, the disc 151, and a valve base 25 are stacked on a head part 102 of the pin member 101 shown in FIG. 12 in that order with the shaft part 103 of the pin member 101 fitted inside each of them. At that time, the partition member 255B is directed such that the outer circumferential disc 282 is positioned on the valve disc 154 side. Here, a thickness of the outer circumferential disc 282 is larger than a thickness of the disc 280.

In the partition member 255B, an inner circumferential side of the base plate disc 281 is clamped between the discs 151 and 280 by fastening the head part 102 of the pin member 101 and the nut 201. In a state of being incorporated in the body valve 30B, the partition member 255B has a portion of the base plate part 281 on an inner circumferential side having a flat plate shape, and a portion of the base plate part 281 on an outer circumferential side deformed into a tapered shape such that it becomes further away from the valve disc 154 in an axial direction toward the outer side in a radial direction. Also, in this state, the partition member 255B comes into contact with the valve disc 154 with the outer circumferential disc 282 to have a tapered shape such that it becomes further away from the valve disc 154 in the axial direction toward the outer side in the radial direction. At that time, the outer circumferential disc 282 is in contact with an annular portion of the valve disc 154 between a notch 171 and a passage hole 172 in the radial direction over the entire circumference. Therefore, the partition member 255B is provided to cover the passage hole 172 of the valve disc 154.

The body valve 30B has a second passage 221B, which is partially different from the second passage 221, instead of the second passage 221. The second passage 221B has a variable chamber 220B, which is partially different from the variable chamber 220, instead of the variable chamber 220. The variable chamber 220B is formed to be surrounded by a base main body part 82, an inner seat 84, an outer seat 88, and a plurality of protruding parts 89 of the valve base 25, the disc 151, the partition member 255B, and the valve disc 154.

In the body valve 30B, the base main body part 82, the inner seat 84, the outer seat 88, and the plurality of protruding parts 89 of the valve base 25, the partition member 255B, the valve disc 154, and the discs 151 and 280 constitute the pressure accumulation mechanism 251B including the variable chamber 220B. A portion of the pressure accumulation mechanism 251B surrounded by the partition member 255B, the disc 280, and the valve disc 154 is a variable chamber 252B. The variable chamber 252B is partitioned from the variable chamber 220B of the second passage 221B by the partition member 255B. The variable chamber 252B communicates with a fourth passage 241. The partition member 255B seals between the variable chamber 252B and the variable chamber 220B in a state in which the outer circumferential disc 282 is in contact with the valve disc 154 over the entire circumference.

The partition member 255B is movable according to a change in pressure of a reservoir chamber 18 on an upstream side or a second chamber 49 (see FIG. 2) on a downstream side when a piston 45 (see FIG. 1) moves in an extension direction. The partition member 255B is movable according to a change in pressure of the second chamber 49 (see FIG. 2) on an upstream side or the reservoir chamber 18 on a downstream side when the piston 45 (see FIG. 1) moves in a compression direction. The partition member 255B increases the variable chamber 252B and decreases the variable chamber 220B during an extension stroke of the piston 45 (see FIG. 1) while increasing the variable chamber 220B and decreasing the variable chamber 252B during a compression stroke of the piston 45 (see FIG. 1).

The variable chambers 220B and 252B are formed by a second damping disc valve 222B. The variable chambers 220B and 252B are disposed to overlap the second damping disc valve 222B in an axial direction of the second damping disc valve 222B. The pressure accumulation mechanism 251B including the variable chambers 220B and 252B is disposed to overlap the second damping disc valve 222B in the axial direction of the second damping disc valve 222B.

During the extension stroke in which a piston speed is in a low speed region, the partition member 255B increases the variable chamber 252B while the outer circumferential disc 282 remains in contact with the valve disc 154 over the entire circumference. Also, the partition member 255B increases the variable chamber 220B during the compression stroke. Here, during the extension stroke in which the piston speed is in a high speed region, the outer circumferential disc 282 of the partition member 255B separates from the valve disc 154 to allow the variable chamber 252B to communicate with the variable chamber 220B. At that time, the partition member 255B comes into contact with the protruding part 89 of the valve base 25 with the base plate disc 281, and thereby any further deformation is curbed.

The shock absorber 11B of the third embodiment and the body valve 30B thereof achieve substantially the same effects as in the first embodiment.

### Fourth Embodiment

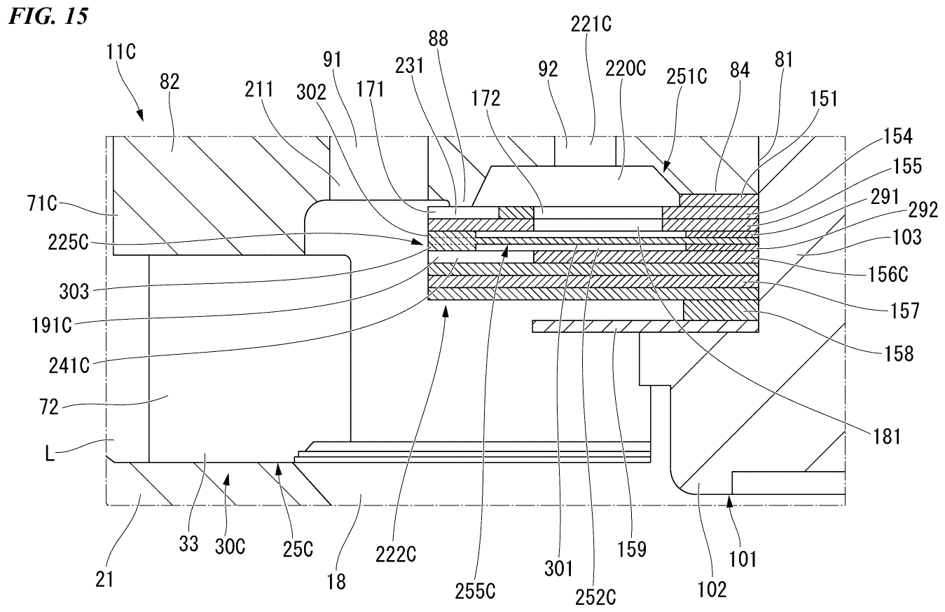

Next, a fourth embodiment will be described mainly on the basis of FIGS. 15 to 18, focusing on differences from the first embodiment. Further, parts common to those in the first embodiment will be denoted by the same terms and the same reference signs.

As shown in FIG. 15, a shock absorber 11C of the fourth embodiment includes a body valve 30C, which is partially different from the body valve 30, instead of the body valve 30. The body valve 30C includes a valve base 25C, which is partially different from the valve base 25, instead of the valve base 25.

The valve base 25C has includes a base part 71C, which is partially different from the base part 71, instead of the base part 71. The base part 71C differs from the base part 71 in that the protruding part 89 is not provided.

One disc 151 similar to the above, one valve disc 154 similar to the above, one valve disc 155 similar to the above, one disc 291, one partition member 255C, one disc 292, one valve disc 156C, a plurality of, specifically three, valve discs 157 similar to the above, one disc 158 similar to the above, and one disc 159 similar to the above are provided in the body valve 30C on a leg part 72 side of the base part 71C in the axial direction in order from the base part 71C side in the axial direction.

The valve disc 156C and the discs 291 and 292 are all made of a metal. The valve disc 156C and the discs 291 and 292 all have a perforated disc shape with a constant thickness into which a shaft part 103 of a pin member 101 can be fitted. The partition member 255C has an annular shape into which the shaft part 103 of the pin member 101 can be fitted.

The discs 291 and 292 are common parts having the same shape. An outer diameter of the discs 291 and 292 is smaller than a diameter of a passage hole 181 of the valve disc 155.

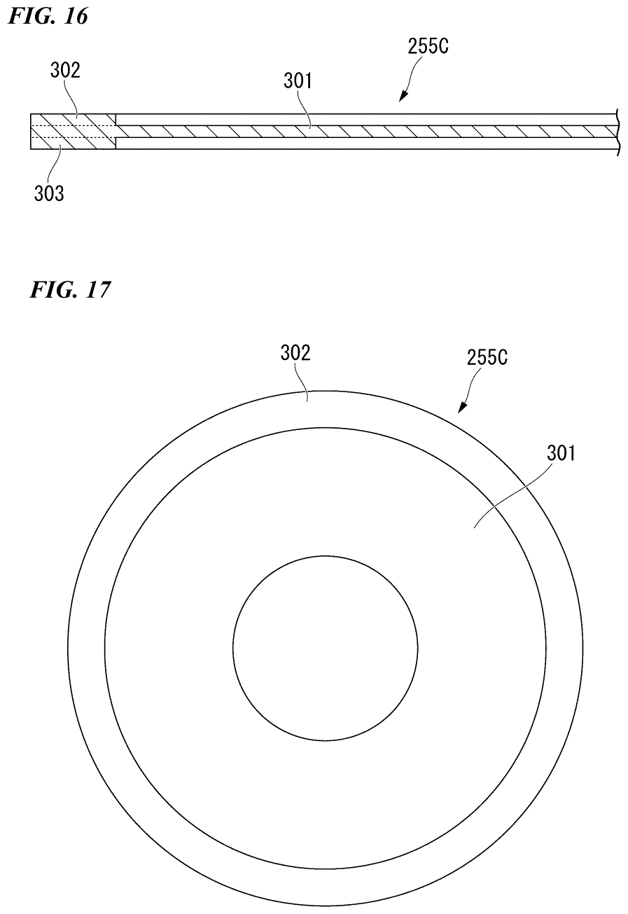

As shown in FIGS. 16 and 17, the partition member 255C includes a base plate disc 301 and a pair of outer circumferential discs 302 and 303 having the same shape. The base plate disc 301 and the pair of outer circumferential discs 302 and 303 are all made of a metal.

As shown in FIG. 15, in the partition member 255C, the base plate disc 301 has a perforated disc shape with a constant thickness into which the shaft part 103 of the pin member 101 can be fitted. The base plate disc 301 is bendable. Also, in the partition member 255C, the pair of outer circumferential discs 302 and 303 have a perforated disc shape with a constant thickness. The pair of outer circumferential discs 302 and 303 of the partition member 255C have an outer diameter that is the same as an outer diameter of the base plate disc 301, and have an inner diameter larger than an inner diameter of the base plate disc 301.

As shown in FIG. 17, the outer circumferential disc 302 is coaxial with the base plate disc 301 and is fixed to one side of the base plate disc 301 in the axial direction by welding. The outer circumferential disc 303 shown in FIG. 16 is coaxial with the base plate disc 301 and is fixed to the other side of the base plate disc 301 opposite to the outer circumferential disc 302 in the axial direction by welding. As shown in FIG. 15, an outer diameter of the partition member 255C, that is, an outer diameter of the base plate disc 301 and the pair of outer circumferential discs 302 and 303, is the same as an outer diameter of the valve discs 154, 155, and 157. A thickness of the outer circumferential disc 302 is the same as a thickness of the disc 291, and a thickness of the outer circumferential disc 303 is the same as a thickness of the disc 292.

The valve disc 156C has an outer diameter the same as an outer diameter of the valve discs 154, 155, and 157. The valve disc 156C is bendable. A notch 191C is formed on an outer circumferential side of the valve disc 156C.

When the body valve 30C is assembled, the disc 159, the disc 158, the plurality of valve discs 157, the valve disc 156C, the disc 292, the partition member 255C, the disc 291, the valve disc 155, the valve disc 154, the disc 151, and the valve base 25C are stacked on a head part 102 of the pin member 101 in that order with the shaft part 103 of the pin member 101 fitted inside each of them.

The disc 159, the disc 158, the plurality of valve discs 157, the valve disc 156C, the disc 292, the partition member 255C, the disc 291, the valve disc 155, the valve disc 154, and the disc 151 are clamped by the head part 102 of the pin member 101 and an inner seat 84 of the valve base 25C at least at their inner circumferential sides. In the partition member 255C, an inner circumferential side of the base plate disc 301 is clamped by the discs 291 and 292.

The body valve 30C has a second passage 221C, which is partially different from the second passage 221, instead of the second passage 221. The second passage 221C includes a variable chamber 220C, which is partially different from the variable chamber 220, instead of the variable chamber 220. The variable chamber 220C is formed by a portion surrounded by a base main body part 82, the inner seat 84, and an outer seat 88 of the valve base 25C, the disc 151, and the valve disc 154, and a portion surrounded by the passage holes 172 and 181 of the valve discs 154 and 155, the partition member 255C, the valve disc 155, and the disc 291.

In the body valve 30C, the valve discs 154, 155, 156C, and 157, and the partition member 255C serve as a second damping disc valve 222C which opens and closes the second passage 221C by being separated from and coming into contact with the outer seat 88. A flow of an oil fluid L, which serves as a working fluid, occurs in the second passage 221C due to movement of a piston 45 (see FIG. 1) in a compression direction. The second damping disc valve 222C provides resistance to a flow of the oil fluid L from a second chamber 49 (see FIG. 2) on an upstream side to a reservoir chamber 18 on a downstream side of the second passage 221C. The second damping disc valve 222C and a third passage 231, which is an orifice, are provided in the second passage 221C and constitute a second damping force generation mechanism 225C on the compression side which suppresses a flow of the oil fluid L flowing inside the second passage 221C to generate a damping force.

In the body valve 30C, the inside of the notch 191C of the valve disc 156C serves as a fourth passage 241C (communication passage) that is in constant communication with the reservoir chamber 18 on an upstream side when the piston 45 (see FIG. 1) moves in an extension direction. In other words, the second damping disc valve 222C has the fourth passage 241C. The fourth passage 241C is an orifice.

A part of the variable chamber 220C of the second passage 221C and the third passage 231 are formed in the valve disc 154 of the second damping disc valve 222C seated on the outer seat 88.

In the body valve 30C, the base main body part 82, the inner seat 84, and the outer seat 88 of the valve base 25C, the valve discs 154, 155, and 156C, the partition member 255C, and the discs 151, 291, and 292 constitute a pressure accumulation mechanism 251C including the variable chamber 220C.

A portion of the pressure accumulation mechanism 251C surrounded by the valve disc 156C, the partition member 255C, and the disc 292 is a variable chamber 252C. The variable chamber 252C is partitioned from the variable chamber 220C of the second passage 221C by the partition member 255C. The variable chamber 252C communicates with the fourth passage 241C.

The partition member 255C is movable according to a change in pressure of the reservoir chamber 18 on the upstream side or the second chamber 49 (see FIG. 2) on a downstream side when the piston 45 (see FIG. 1) moves in the extension direction. The partition member 255C is movable according to a change in pressure of the second chamber 49 (see FIG. 2) on the upstream side or the reservoir chamber 18 on the downstream side when the piston 45 (see FIG. 1) moves in a compression direction. The partition member 255C increases the variable chamber 252C and decreases the variable chamber 220C during an extension stroke of the piston 45 (see FIG. 1) while increasing the variable chamber 220C and decreasing the variable chamber 252C during a compression stroke of the piston 45 (see FIG. 1).

When the partition member 255C deforms in a direction that increases the variable chamber 252C and reaches a predetermined amount of deformation, the base plate disc 301 comes into contact with the valve disc 155 and any further deformation is curbed. When the partition member 255C deforms in a direction that increases the variable chamber 220C and reaches a predetermined amount of deformation, the base plate disc 301 comes into contact with the valve disc 156C and any further deformation is curbed. The outer circumferential disc 302 of the partition member 255C is in constant contact with the valve disc 155 over the entire circumference.

The pressure accumulation mechanism 251C has the variable chamber 252C communicating with the fourth passage 241C. The variable chamber 252C is partitioned from the second passage 221C by the partition member 255C that is movable according to a change in pressure of the reservoir chamber 18 on the upstream side or the second chamber 49 (see FIG. 2) on the downstream side when the piston 45 (see FIG. 1) moves in the extension direction.

The variable chambers 220C and 252C are formed by the second damping disc valve 222C. The variable chamber 252C is disposed inside the second damping disc valve 222C. The variable chambers 220C and 252C are disposed to overlap the second damping disc valve 222C in an axial direction of the second damping disc valve 222C. The pressure accumulation mechanism 251C including the variable chambers 220C and 252C is disposed to overlap the second damping disc valve 222C in the axial direction of the second damping disc valve 222C.

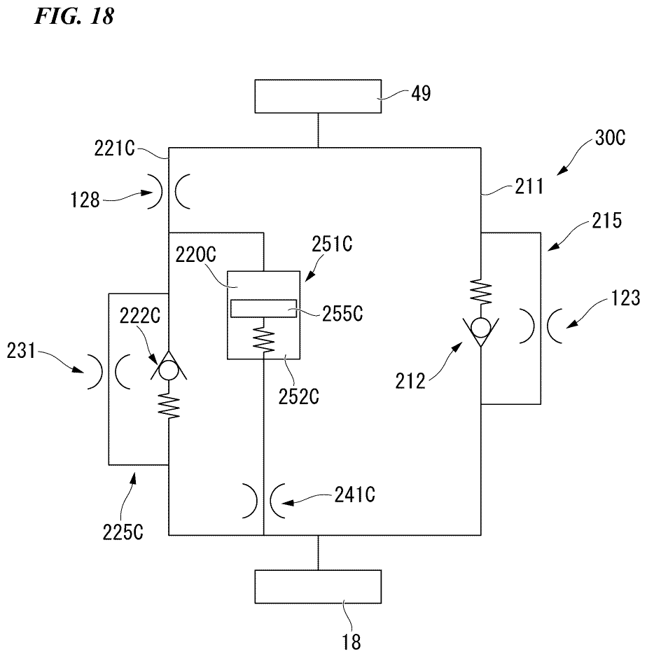

A hydraulic circuit diagram of the body valve 30C described above is shown in FIG. 18.

In the body valve 30C, the orifice 128 and the second damping force generation mechanism 225C on the compression side which includes the second damping disc valve 222C and the third passage 231 are provided in the second passage 221C which allows communication between the second chamber 49 and the reservoir chamber 18. Also, the body valve 30C includes the variable chamber 220C provided between the orifice 128 and the second damping force generation mechanism 225C of the second passage 221C. Also, in the body valve 30C, the variable chamber 252C of the pressure accumulation mechanism 251C communicates with the reservoir chamber 18 through the fourth passage 241C serving as an orifice. A relief mechanism is not provided in the body valve 30C.

Next, main operations of the body valve 30C will be described.

During the extension stroke, a pressure in the second chamber 49 (see FIG. 2) becomes lower than a pressure in the reservoir chamber 18 shown in FIG. 15, and the oil fluid L in the reservoir chamber 18 is introduced into a first passage 211 and flows into the second chamber 49 (see FIG. 2) via the first damping force generation mechanism 215 (see FIG. 2). In addition to this, the oil fluid L in the reservoir chamber 18 is introduced from the fourth passage 241C into the variable chamber 252C of the pressure accumulation mechanism 251C and deforms the partition member 255C to expand the variable chamber 252C. At that time, the oil fluid L in the variable chamber 220C that is reduced in size is discharged to the second chamber 49 (see FIG. 2) through the second passage 221C.

During the extension stroke at a low frequency in which a piston frequency is lower than a predetermined value, since a stroke of the piston 45 (see FIG. 1) is large, at the beginning of the introduction of the oil fluid L from the reservoir chamber 18 to the variable chamber 252C through the fourth passage 241C, the partition member 255C is largely bent, the base plate disc 301 comes into contact with the valve disc 155, and thereby any further deformation is curbed. Thereby, the variable chamber 252C is placed in a state in which an increase in volume is suppressed, and the variable chamber 252C can no longer absorb an increase in the oil fluid L being introduced. Then, a force of the oil fluid L in the reservoir chamber 18 pushing the first damping valve 212 (see FIG. 2) in an opening direction becomes higher. Therefore, the first damping valve 212 (see FIG. 2) opens and allows the oil fluid L to flow into the second chamber 49 (see FIG. 2) through the first passage 211. Therefore, during the extension stroke at a low frequency in which the piston frequency is lower than the predetermined value, damping force characteristics are the same as in a case in which the pressure accumulation mechanism 251C is not provided.

On the other hand, during the extension stroke at a high frequency in which the piston frequency is equal to or higher than the predetermined value, since the stroke of the piston 45 (see FIG. 1) is small, a volume of the oil fluid L introduced into the variable chamber 252C from the reservoir chamber 18 through the fourth passage 241C is small. Therefore, the partition member 255C also has a small amount of bending, and does not come into contact with the valve disc 155, or is deformable even if it does come into contact with it. Therefore, most of the increase in the oil fluid L introduced into the variable chamber 252C from the reservoir chamber 18 through the fourth passage 241C is absorbed by the bending of the partition member 255C. Then, the force of the oil fluid L in the reservoir chamber 18 pushing the first damping valve 212 (see FIG. 2) in the opening direction is further suppressed than that at the low frequency in which the piston frequency is lower than the predetermined value, and the damping force becomes lower and softer than that at the low frequency.

During the compression stroke, a pressure in the second chamber 49 (see FIG. 2) becomes higher than a pressure in the reservoir chamber 18, and the oil fluid L in the second chamber 49 (see FIG. 2) is introduced into the second passage 221C and flows into the reservoir chamber 18 via the second damping force generation mechanism 225C. In addition to this, the oil fluid L in the second chamber 49 (see FIG. 2) is introduced into the variable chamber 220C of the pressure accumulation mechanism 251C and deforms the partition member 255C to expand the variable chamber 220C. At that time, the oil fluid L in the variable chamber 252C that is reduced in size is discharged into the reservoir chamber 18 through the fourth passage 241C.

During the compression stroke in which the piston frequency is lower than the predetermined value, since the stroke of the piston 45 (see FIG. 1) is large, at the beginning of the introduction of the oil fluid L from the second chamber 49 (see FIG. 2) into the variable chamber 220C, the partition member 255C is largely bent and comes into contact with the valve disc 156C, and thereby any further deformation is curbed. Thereby, a volume of the variable chamber 220C remains unchanged, and the variable chamber 220C is no longer able to absorb the increase in the oil fluid L being introduced. Then, a pressure in the variable chamber 220C increases to a high pressure, and thus a force pushing the second damping disc valve 222C in the opening direction becomes higher. Therefore, the second damping disc valve 222C opens and allows the oil fluid L to flow into the reservoir chamber 18 through a gap between itself and the outer seat 88. Therefore, during the compression stroke at a low frequency in which the piston frequency is lower than the predetermined value, damping force characteristics are the same as in a case in which the pressure accumulation mechanism 251C is not provided.

On the other hand, during the compression stroke in which the piston frequency is equal to or higher than the predetermined value, since the stroke of the piston 45 (see FIG. 1) is small, and a volume of the oil fluid L introduced from the second chamber 49 (see FIG. 2) into the variable chamber 220C is small, the partition member 255C also has a small amount of bending and is likely to be deformed. Therefore, most of the increase in the oil fluid L introduced into the variable chamber 220C from the second chamber 49 (see FIG. 2) is absorbed by the bending of the partition member 255C. Therefore, the pressure in the variable chamber 220C is low, and an opening pressure of the second damping disc valve 222C does not increase. Therefore, in the compression stroke, when the piston frequency is high, the damping force becomes lower and softer than when the piston frequency is low.

The shock absorber 11C of the fourth embodiment and the body valve 30C thereof achieve substantially the same effects as in the first embodiment.

Further, although the shock absorber 11C of the fourth embodiment does not have a relief mechanism, the partition member 255C, which is deformed by a differential pressure between the variable chambers 220C and 252C, is sandwiched between the valve disc 155 and the valve disc 156C, and even in a high speed region, deformation is limited by the valve disc 155 or the valve disc 156, and an excessive increase in stress is suppressed.

### Fifth Embodiment

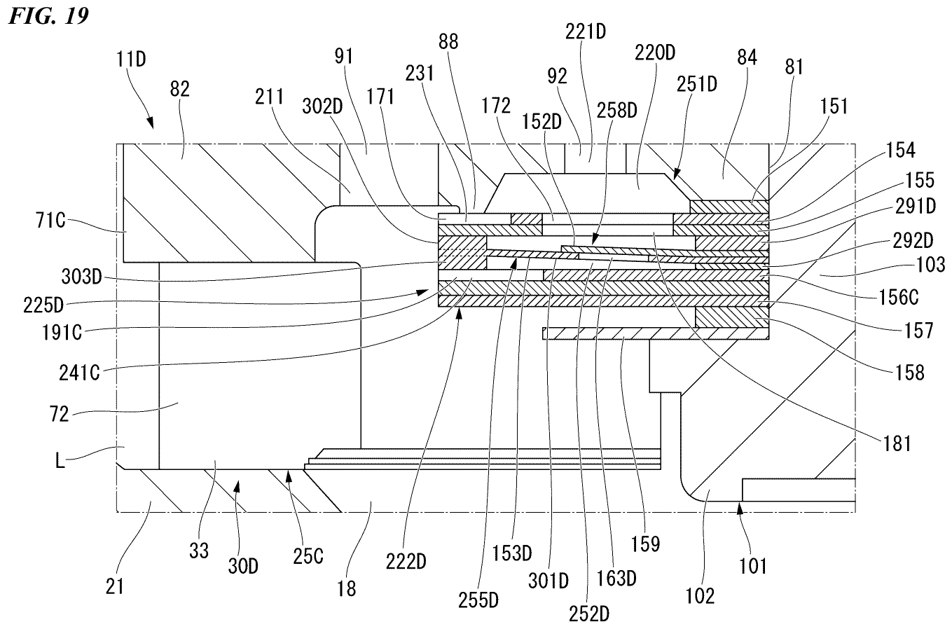

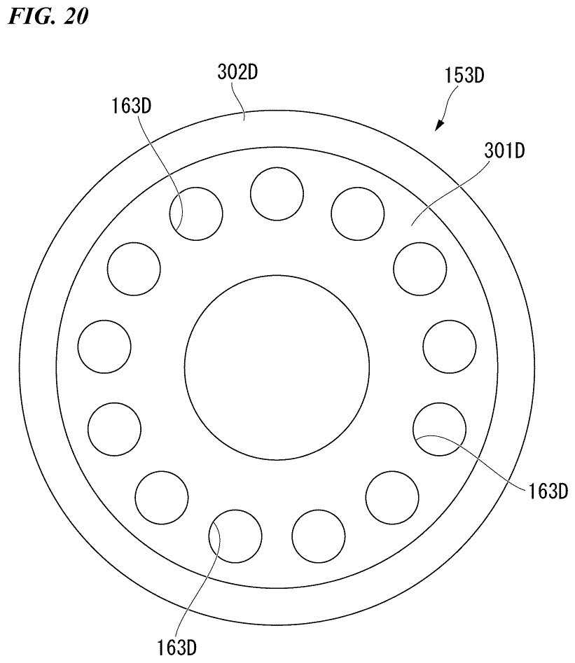

Next, a fifth embodiment will be described mainly on the basis of FIGS. 19 to 20, focusing on differences from the fourth embodiment. Further, parts common to those in the fourth embodiment will be denoted by the same terms and the same reference signs.

As shown in FIG. 19, a shock absorber 11D of the fifth embodiment includes a body valve 30D, which is partially different from the body valve 30C, instead of the body valve 30C. The body valve 30D includes a partition member 255D instead of the partition member 255C.

The partition member 255D includes a partition member main body 153D and an opening/closing disc 152D. A shaft part 103 of a pin member 101 can be fitted inside both the partition member main body 153D and the opening/closing disc 152D.

The partition member main body 153D includes a base plate disc 301D, and a pair of outer circumferential discs 302D and 303D having the same shape.

The base plate disc 301D and the pair of outer circumferential discs 302D and 303D are all made of a metal.

The base plate disc 301D of the partition member main body 153D has a perforated disc shape with a constant thickness in a natural state before being incorporated into the body valve 30D. The base plate disc 301D is bendable. A passage hole 163D penetrating the base plate disc 301D in an axial direction is formed in the base plate disc 301D at a center position in a radial direction. As shown in FIG. 20, a plurality of, specifically 13, passage holes 163D are formed in the base plate disc 301D at regular intervals in a circumferential direction thereof.

Also, in the partition member main body 153D, the pair of outer circumferential discs 302D and 303D shown in FIG. 19 have a perforated disc shape with a constant thickness. In the partition member main body 153D, an outer diameter of the pair of outer circumferential discs 302D and 303D is the same as an outer diameter of the base plate disc 301D. An inner diameter of the pair of outer circumferential discs 302D and 303D is larger than an inner diameter of the base plate disc 301D.

As shown in FIG. 20, the outer circumferential disc 302D is coaxial with the base plate disc 301D, and is fixed to one side of the base plate disc 301D in the axial direction by welding. The outer circumferential disc 303D shown in FIG. 19 is coaxial with the base plate disc 301D, and is fixed to the other side of the base plate disc 301D opposite to the outer circumferential disc 302D in the axial direction by welding. The outer diameter of the partition member main body 153D, that is, the outer diameter of the base plate disc 301D and the pair of outer circumferential discs 302D and 303D having the same shape, is the same as an outer diameter of valve discs 154, 155, 156c, and 157. The plurality of passage holes 163D are formed in the base plate disc 301D inside the pair of outer circumferential discs 302D and 303D in the radial direction.

The opening/closing disc 152D has a perforated disc shape with a constant thickness in a natural state before being incorporated into the body valve 30D. The opening/closing disc 152D is bendable. The opening/closing disc 152D can close the plurality of passage holes 163D by coming into surface contact with the base plate disc 301D of the partition member main body 153D.

The body valve 30D includes a disc 291D having a different thickness from the disc 291, and a disc 292D having a different thickness from the disc 292. The discs 291D and 292D have the same outer diameter. A thickness of the outer circumferential disc 302D is smaller than a thickness of the disc 291D. A thickness of the outer circumferential disc 303D is smaller than a thickness of the disc 292D.

When the body valve 30D is assembled, a disc 159, a disc 158, a plurality of (specifically, two) valve discs 157, the valve disc 156C, the disc 292D, the partition member main body 153D, the opening/closing disc 152D, the disc 291D, the valve disc 155, the valve disc 154, a disc 151, and a valve base 25C are stacked on a head part 102 of the pin member 101 in that order with the shaft part 103 of the pin member 101 fitted inside each of them.

The disc 159, the disc 158, the plurality of valve discs 157, the valve disc 156C, the disc 292D, the partition member main body 153D, the opening/closing disc 152D, the disc 291D, the valve disc 155, the valve disc 154, and the disc 151 are clamped by the head part 102 of the pin member 101 and an inner seat 84 of the valve base 25C at least at their inner circumferential sides. In the partition member main body 153D, an inner circumferential side of the base plate disc 301D is clamped by the discs 291D and 292D.

In a state of being incorporated in the body valve 30D, the base plate disc 301D of the partition member main body 153D has a portion on an inner circumferential side and a portion on an outer circumferential side which have a flat plate shape, and an intermediate portion between them is deformed in a tapered shape such that it approaches the valve disc 155 in the axial direction toward the outer side in the radial direction.

In a state of being incorporated in the body valve 30D, the opening/closing disc 152D has a portion on an inner circumferential side that has a flat plate shape, and has a portion on an outer circumferential side that is deformed in a tapered shape such that it approaches the valve disc 155 in the axial direction toward the outer side in the radial direction following the base plate disc 301D. Therefore, the opening/closing disc 152D comes into surface contact with the base plate disc 301D with an elastic force thereof to close the plurality of passage holes 163d.

The body valve 30D has a second passage 221D, which is partially different from the second passage 221C, instead of the second passage 221C. The second passage 221D has a variable chamber 220D, which is partially different from the variable chamber 220C, instead of the variable chamber 220C. The variable chamber 220D is constituted by a portion surrounded by a base main body part 82, the inner seat 84, and an outer seat 88 of the valve base 25C, the disc 151, and the valve disc 154, and a portion surrounded by passage holes 172 and 181 of the valve discs 154 and 155, the partition member 255D, the valve disc 155, and the disc 291D.

In the body valve 30D, the valve discs 154, 155, 156C, and 157, and the partition member 255D serve as a second damping disc valve 222D which opens and closes the second passage 221D by being separated from and coming into contact with the outer seat 88. A flow of an oil fluid L, which serves as a working fluid, occurs in the second passage 221D due to movement of a piston 45 (see FIG. 1) in a compression direction. The second damping disc valve 222D provides resistance to a flow of the oil fluid L from a second chamber 49 (see FIG. 1) on an upstream side to a reservoir chamber 18 on a downstream side of the second passage 221D. The second damping disc valve 222D and a third passage 231, which is an orifice, are provided in the second passage 221D and constitute a second damping force generation mechanism 225D on a compression side which suppresses a flow of the oil fluid L flowing inside the second passage 221D to generate a damping force.

A part of the variable chamber 220D of the second passage 221D and the third passage 231 are formed in the valve disc 154 of the second damping disc valve 222D seated on the outer seat 88.

In the body valve 30D, the base main body part 82, the inner seat 84, and the outer seat 88 of the valve base 25C, the valve discs 154, 155, and 156C, the partition member 255D, and the discs 151, 291D, and 292D constitute a pressure accumulation mechanism 251D including the variable chamber 220D.

A portion of the pressure accumulation mechanism 251D surrounded by the valve disc 156C, the partition member 255D, and the disc 292D is a variable chamber 252D. The variable chamber 252D is partitioned from the variable chamber 220D of the second passage 221D by the partition member 255D. The variable chamber 252D communicates with a fourth passage 241C.

The partition member 255D is movable according to a change in pressure of the reservoir chamber 18 on an upstream side or the second chamber 49 (see FIG. 2) on a downstream side when the piston 45 (see FIG. 1) moves in the extension direction. The partition member 255D is movable according to a change in pressure of the second chamber 49 (see FIG. 2) on an upstream side or the reservoir chamber 18 on a downstream side when the piston 45 (see FIG. 1) moves in the compression direction. The partition member 255D increases the variable chamber 252D and decreases the variable chamber 220D during an extension stroke of the piston 45 (see FIG. 1) while increasing the variable chamber 220D and decreasing the variable chamber 252D during a compression stroke of the piston 45 (see FIG. 1).

When the partition member 255D deforms in a direction that increases the variable chamber 220D and reaches a predetermined amount of deformation, the base plate disc 301D of the partition member main body 153D comes into contact with the valve disc 156C and any further deformation is curbed. The outer circumferential disc 302D of the partition member 255D is in constant contact with the valve disc 155 over the entire circumference.

The pressure accumulation mechanism 251D includes the variable chamber 252D communicating with the fourth passage 241C. The variable chamber 252D is partitioned from the variable chamber 220D of the second passage 221D by the partition member 255D that is movable according to a change in pressure of the reservoir chamber 18 on the upstream side or the second chamber 49 (see FIG. 2) on the downstream side when the piston 45 (see FIG. 1) moves in the extension direction.

The variable chambers 220D and 252D are formed by the second damping disc valve 222D. The variable chamber 252D is positioned inside the second damping disc valve 222D. The variable chambers 220D and 252D are disposed to overlap the second damping disc valve 222D in an axial direction of the second damping disc valve 222D. The pressure accumulation mechanism 251D including the variable chambers 220D and 252D is disposed to overlap the second damping disc valve 222D in the axial direction of the second damping disc valve 222D.

The passage hole 163D of the partition member main body 153D and the opening/closing disc 152D constitute a relief mechanism 258D that relieves the inside of the variable chamber 252D after a differential pressure between the variable chamber 252D on the upstream side and the variable chamber 220D on the downstream side when the piston 45 (see FIG. 1) moves in the extension direction reaches a predetermined value.

A hydraulic circuit diagram of the body valve 30D is similar to that of the body valve 30.

Next, main operations of the body valve 30D will be described.

During the extension stroke, a pressure in the second chamber 49 (see FIG. 2) becomes lower than a pressure in the reservoir chamber 18, and the oil fluid L in the reservoir chamber 18 is introduced into a first passage 211 and flows into the second chamber 49 (see FIG. 2) via a first damping force generation mechanism 215 (see FIG. 2). In addition to this, the oil fluid L in the reservoir chamber 18 is introduced from the fourth passage 241C into the variable chamber 252D of the pressure accumulation mechanism 251D and deforms the partition member 255D to expand the variable chamber 252D. At that time, the oil fluid L in the variable chamber 220D that is reduced in size is discharged to the second chamber 49 (see FIG. 2) through the second passage 221D.

During the extension stroke at a low speed in which a piston speed is lower than a predetermined value and at a low frequency in which a piston frequency is lower than a predetermined value, since a stroke of the piston 45 (see FIG. 1) is large, at the beginning of the introduction of the oil fluid L from the reservoir chamber 18 to the variable chamber 252D through the fourth passage 241C, the partition member 255D is largely bent, and any further deformation is curbed. Thereby, the variable chamber 252D is placed in a state in which an increase in volume is suppressed, and the variable chamber 252D can no longer absorb an increase in the oil fluid L being introduced. Then, a force of the oil fluid L in the reservoir chamber 18 pushing the first damping valve 212 (see FIG. 2) in an opening direction becomes higher. Therefore, the first damping valve 212 (see FIG. 2) opens and allows the oil fluid L to flow into the second chamber 49 (see FIG. 2) through the first passage 211. Therefore, during the extension stroke at a low speed in which the piston speed is lower than the predetermined value and at a low frequency in which the piston frequency is lower than the predetermined value, damping force characteristics are the same as in a case in which the pressure accumulation mechanism 251D is not provided.

On the other hand, even at a low speed in which the piston speed is lower than the predetermined value, during the extension stroke at a high frequency in which the piston frequency is equal to or higher than the predetermined value, since the stroke of the piston 45 (see FIG. 1) is small, a volume of the oil fluid L introduced into the variable chamber 252D from the reservoir chamber 18 through the fourth passage 241C is small. Therefore, the partition member 255D also has a small amount of bending. Therefore, most of the increase in the oil fluid L introduced into the variable chamber 252D from the reservoir chamber 18 through the fourth passage 241C is absorbed by the bending of the partition member 255D. Then, the force of the oil fluid L in the reservoir chamber 18 pushing the first damping valve 212 (see FIG. 2) in the opening direction is further suppressed than that at the low frequency in which the piston frequency is lower than the predetermined value, and the damping force becomes lower and softer than that at the low frequency.

Also, during the extension stroke at a high speed in which the piston speed is equal to or higher than the predetermined value, the opening/closing disc 152D deforms and separates from the partition member main body 153D. In other words, the relief mechanism 258D opens. Thereby, the oil fluid L in the variable chamber 252D is allowed to flow into the second chamber 49 (see FIG. 2) through the second passage 221D including the variable chamber 220D.

During the compression stroke, a pressure in the second chamber 49 (see FIG. 2) becomes higher than a pressure in the reservoir chamber 18, and the oil fluid L in the second chamber 49 (see FIG. 2) is introduced into the second passage 221D and flows into the reservoir chamber 18 via the second damping force generation mechanism 225D. In addition to this, the oil fluid L in the second chamber 49 (see FIG. 2) is introduced into the variable chamber 220D of the pressure accumulation mechanism 251D and deforms the partition member 255D to expand the variable chamber 220D. At that time, the oil fluid L in the variable chamber 252D that is reduced in size is discharged into the reservoir chamber 18 through the fourth passage 241C.

During the compression stroke in which the piston frequency is lower than the predetermined value, since the stroke of the piston 45 (see FIG. 1) is large, at the beginning of the introduction of the oil fluid L from the second chamber 49 (see FIG. 2) into the variable chamber 220D, the partition member 255D is largely bent and comes into contact with the valve disc 156C, and any further deformation is curbed. Thereby, a volume of the variable chamber 220D remains unchanged, and the variable chamber 220D is no longer able to absorb the increase in the oil fluid L being introduced. Then, a pressure in the variable chamber 220D increases to a high pressure, and thus a force pushing the second damping disc valve 222D in the opening direction becomes higher. Therefore, the second damping disc valve 222D opens and allows the oil fluid L to flow into the reservoir chamber 18 through a gap between itself and the outer seat 88. Therefore, during the compression stroke at a low frequency in which the piston frequency is lower than the predetermined value, damping force characteristics are the same as in a case in which the pressure accumulation mechanism 251D is not provided.

On the other hand, during the compression stroke in which the piston frequency is equal to or higher than the predetermined value, since the stroke of the piston 45 (see FIG. 1) is small, and a volume of the oil fluid L introduced from the second chamber 49 (see FIG. 2) into the variable chamber 220D is small, the partition member 255D also has a small amount of bending and is likely to be deformed. Therefore, most of the increase in the oil fluid L introduced into the variable chamber 220D from the second chamber 49 (see FIG. 2) is absorbed by the bending of the partition member 255D. Therefore, the pressure in the variable chamber 220D is low, and an opening pressure of the second damping disc valve 222D does not increase. Therefore, in the compression stroke, when the piston frequency is high, the damping force becomes lower and softer than when the piston frequency is low.

The shock absorber 11D of the fifth embodiment and the body valve 30D thereof achieve the same effects as in the first embodiment.

### Sixth Embodiment

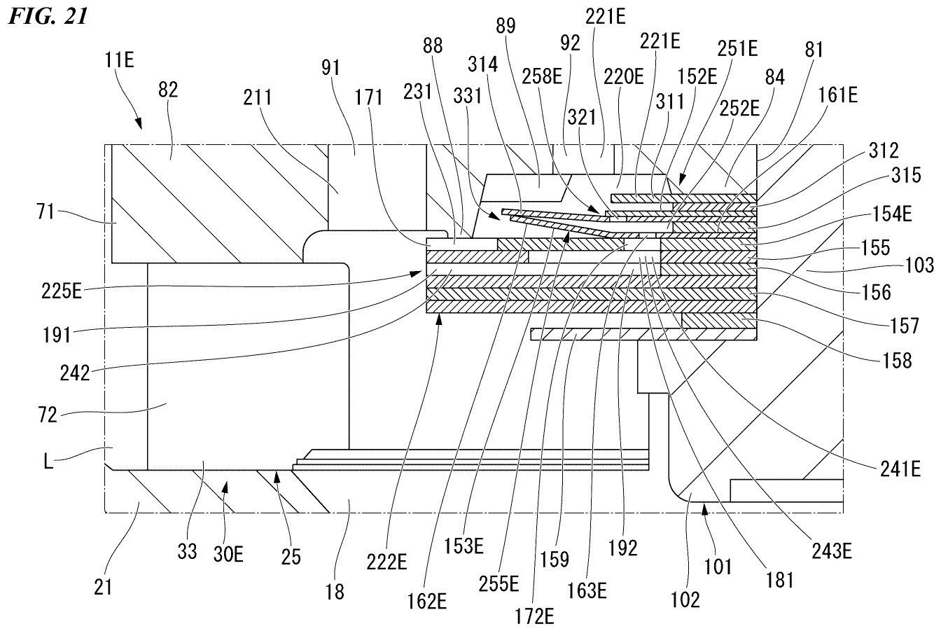

Next, a sixth embodiment will be described mainly on the basis of FIG. 21, focusing on differences from the first embodiment. Further, parts common to those in the first embodiment will be denoted by the same terms and the same reference signs.

As shown in FIG. 21, a shock absorber 11E of the sixth embodiment includes a body valve 30E, which is partially different from the body valve 30, instead of the body valve 30.

One disc 311, one disc 312, one opening/closing disc 152E, one partition disc 314, one disc 315, one disc spring 153E, one valve disc 154E, one valve disc 155 similar to the above, one valve disc 156 similar to the above, a plurality of, specifically three, valve discs 157 similar to the above, one disc 158 similar to the above, and one disc 159 similar to the above are provided in the body valve 30E on a leg part 72 side of a base part 71 in an axial direction in order from the base part 71 side in the axial direction.

The valve disc 154E is different from the valve disc 154 in that it has a passage hole 172E which is at a different position from the passage hole 172 and is smaller than the passage hole 172.

The discs 311, 312, and 315, the opening/closing disc 152E, the partition disc 314, and the disc spring 153E are all made of a metal. The discs 311, 312, and 315 all have a perforated disc shape with a constant thickness into which a shaft part 103 of a pin member 101 can be fitted. The opening/closing disc 152E, the disc spring 153E, and the partition disc 314 have an annular shape into which the shaft part 103 of the pin member 101 can be fitted.

The disc 311 has an outer diameter that is larger than an outer diameter of an inner seat 84 of a valve base 25 and does not come into contact with a plurality of protruding parts 89.

The disc 312 has an outer diameter the same as the outer diameter of the inner seat 84 of the valve base 25 and smaller than the outer diameter of the disc 311.

The opening/closing disc 152E has a perforated disc shape with a constant thickness in a natural state before being incorporated into the body valve 30E. The opening/closing disc 152E is bendable. The opening/closing disc 152E has an outer diameter that is larger than the outer diameter of the disc 311 and does not come into contact with the plurality of protruding parts 89 of the valve base 25.

The partition disc 314 has a perforated disc shape with a constant thickness in a natural state before being incorporated into the body valve 30E. The partition disc 314 has an outer diameter that is larger than the outer diameter of the opening/closing disc 152E and can come into contact with the plurality of protruding parts 89. The partition disc 314 is bendable. A plurality of passage holes 321 are formed in the partition disc 314 at positions they are opened and closed by the opening/closing disc 152E at regular intervals in a circumferential direction of the partition disc 314.

The disc 315 has an outer diameter equivalent to the outer diameter of the disc 312.

The disc spring 153E is formed by press-forming one plate material having a flat plate shape. The disc spring 153E has a base plate part 161E and an outer circumferential tapered plate part 162E. The disc spring 153E is bendable.

The base plate part 161E has a perforated disc shape with a constant thickness. A passage hole 163E penetrating the base plate part 161E in an axial direction of the base plate part 161E is formed in the base plate part 161E. A plurality of passage holes 163E are formed in the base plate part 161E at regular intervals in a circumferential direction of the base plate part 161E.

The outer circumferential tapered plate part 162E extends in a tapered shape from an outer circumferential edge portion of the base plate part 161E. The outer circumferential tapered plate part 162E becomes larger in diameter with distance away from the base plate part 161E in the axial direction of the base plate part 161E. The outer circumferential tapered plate part 162E has an annular shape and is formed over the entire circumference of the base plate part 161E.

When the body valve 30E is assembled, the disc 159, the disc 158, the plurality of valve discs 157, the valve disc 156, the valve disc 155, the valve disc 154E, the disc spring 153E, the disc 315, the partition disc 314, the opening/closing disc 152E, the disc 312, the disc 311, and the valve base 25 are stacked on a head part 102 of the pin member 101 in that order with the shaft part 103 of the pin member 101 fitted inside each of them.

At that time, the disc spring 153E is directed such that the outer circumferential tapered plate part 162E extends to a side opposite to the valve disc 154E in the axial direction. Also, at that time, the valve base 25 is directed such that the inner seat 84 is in contact with the disc 311.

In a state of being incorporated in the body valve 30E, the disc 159, the disc 158, the plurality of valve discs 157, the valve disc 156, the valve disc 155, the valve disc 154E, the disc spring 153E, the disc 315, the partition disc 314, the opening/closing disc 152E, the disc 312, and the disc 311 are clamped by the head part 102 of the pin member 101 and the inner seat 84 of the valve base 25 at least at their inner circumferential sides. At that time, the disc spring 153E is clamped by the disc 315 and the valve disc 154E at an inner circumferential side of the base plate part 161E.

In a state of being incorporated in the body valve 30E, the base plate part 161E of the disc spring 153E is in surface contact with the valve disc 154E and allows the passage hole 163E to communicate with the passage hole 172E.

In a state of being incorporated in the body valve 30E, the partition member 314 has a portion on an inner circumferential side that has a flat plate shape, and a portion on an outer circumferential side that comes into contact with an outer circumferential edge portion of the outer circumferential tapered plate part 162E of the disc spring 153E to be deformed in a tapered shape such that it becomes further away from the valve disc 154E in the axial direction toward the outer side in a radial direction.

In a state of being incorporated in the body valve 30E, the opening/closing disc 152E has a portion on an inner circumferential side that has a flat plate shape, and a portion on an outer circumferential side that is deformed following the partition disc 314 to be in surface contact with the partition disc 314 by an elastic force thereof. At that time, the opening/closing disc 152E covers the entirety of the plurality of passage holes 321 of the partition disc 314 to close the plurality of passage holes 321.

The body valve 30E has a second passage 221E, which is partially different from the second passage 221, instead of the second passage 221. The second passage 221E includes a variable chamber 220E surrounded by a base main body part 82, the inner seat 84, an outer seat 88, and the plurality of protruding parts 89 of the valve base 25, the discs 311 and 312, the opening/closing disc 152E, the partition disc 314, the disc spring 153E, and the valve disc 154E. The second passage 221E includes a third passage 231, which is an orifice, in a notch 171 of the valve disc 154E. The third passage 231 allows constant communication between the variable chamber 220E and a reservoir chamber 18.

In the body valve 30E, the valve discs 154E and 155 to 157 serve as a second damping disc valve 222E which opens and closes the second passage 221E by being separated from and coming into contact with the outer seat 88. A flow of an oil fluid L, which serves as a working fluid, occurs in the second passage 221E due to movement of a piston 45 (see FIG. 1) in a compression direction. The second damping disc valve 222E provides resistance to a flow of the oil fluid L from the second chamber 49 (see FIG. 2) on an upstream side to the reservoir chamber 18 on a downstream side of the second passage 221E.

The second damping disc valve 222E and the third passage 231, which is an orifice, are provided in the second passage 221E and constitute a second damping force generation mechanism 225E on a compression side which suppresses a flow of the oil fluid L flowing inside the second passage 221E to generate a damping force.

In the body valve 30E, the inside of the notch 191 and passage hole 192 of the valve disc 156 of the second damping disc valve 222E, the inside of the passage hole 181 of the valve disc 155, and the inside of the passage hole 172E of the valve disc 154E form a fourth passage 241E (communication passage) that is in constant communication with the reservoir chamber 18 on an upstream side when the piston 45 (see FIG. 1) moves in an extension direction.

The fourth passage 241E has an orifice 242 inside the notch 191 of the valve disc 156. In the fourth passage 241E, the inside of the passage hole 192 of the valve disc 156, the inside of the passage hole 181 of the valve disc 155, and the inside of the passage hole 172E of the valve disc 154E form an intermediate chamber 243E.

The third passage 231 and a part of the fourth passage 241E are formed in the valve disc 154E of the second damping disc valve 222E seated on the outer seat 88.

In the body valve 30E, the base main body part 82, the inner seat 84, the outer seat 88, and the plurality of protruding parts 89 of the valve base 25, the discs 311, 312, and 315, the opening/closing disc 152E, the partition disc 314, the disc spring 153E, and the valve disc 154E constitute a pressure accumulation mechanism 251E including the variable chamber 220E.

A portion of the pressure accumulation mechanism 251E surrounded by the opening/closing disc 152E, the partition disc 314, the disc spring 153E, and the disc 315 is a variable chamber 252E. The variable chamber 252E is partitioned from the variable chamber 220E of the second passage 221E by the disc spring 153E, the partition disc 314, and the opening/closing disc 152E. The disc spring 153E, the partition disc 314, and the opening/closing disc 152E constitute a partition member 255E that partitions the variable chamber 252E and the variable chamber 220E. The variable chamber 252E communicates with the fourth passage 241E.

The partition member 255E is movable according to a change in pressure of the reservoir chamber 18 on the upstream side or the second chamber 49 (see FIG. 2) on the downstream side when the piston 45 (see FIG. 1) moves in the extension direction. The partition member 255E is movable according to a change in pressure of the second chamber 49 (see FIG. 2) on the upstream side or the reservoir chamber 18 on the downstream side when the piston 45 (see FIG. 1) moves in the compression direction. The partition member 255E is constituted by the disc spring 153E. The partition member 255E increases the variable chamber 252E and decreases the variable chamber 220E during an extension stroke of the piston 45 (see FIG. 1) while increasing the variable chamber 220E and decreasing the variable chamber 252E during a compression stroke of the piston 45 (see FIG. 1).

When the partition member 255E deforms in a direction that increases the variable chamber 252E and reaches a predetermined amount of deformation, the partition disc 314 comes into contact with the protruding part 89 of the valve base 25 and any further deformation is curbed. At that time, the outer circumferential tapered plate part 162E of the disc spring 153E comes into contact with the partition disc 314 over the entire circumference, and seals between the variable chamber 252E and the variable chamber 220E. When the partition member 255E deforms in a direction that increases the variable chamber 220E and reaches a predetermined amount of deformation, any further deformation is curbed by the valve disc 154E. Even at that time, the outer circumferential tapered plate part 162E of the disc spring 153E comes into contact with the valve disc 154E over the entire circumference, and seals between the variable chamber 252E and the variable chamber 220E.

In the partition member 255E, when a differential pressure between the variable chamber 252E on an upstream side and the variable chamber 220E on a downstream side reaches a predetermined value during movement of the piston 45 (see FIG. 1) in the extension direction, the opening/closing disc 152E separates from the partition disc 314 and opens the passage hole 321 of the partition disc 314 to allow the variable chamber 252E to communicate with the variable chamber 220E. The passage hole 321 of the partition disc 314 and the opening/closing disc 152E constitute a relief mechanism 258E that relieves the inside of the variable chamber 252E after the differential pressure between the variable chamber 252E on the upstream side and the variable chamber 220E on the downstream side when the piston 45 (see FIG. 1) moves in the extension direction reaches the predetermined value.

In the disc spring 153E, when a differential pressure between the variable chamber 252E on the upstream side and the variable chamber 220E on the downstream side reaches a predetermined value during movement of the piston 45 (see FIG. 1) in the extension direction, the outer circumferential tapered plate part 162E separates from the opening/closing disc 152E and allows the variable chamber 252E to communicate with the variable chamber 220E. The outer circumferential tapered plate part 162E of the disc spring 153E and the partition disc 314 constitute a relief mechanism 331 that relieves the inside of the variable chamber 252E after the differential pressure between the variable chamber 252E on the upstream side and the variable chamber 220E on the downstream side when the piston 45 (see FIG. 1) moves in the extension direction reaches the predetermined value. In other words, the partition member 255E includes the relief mechanisms 258E and 331.

The pressure accumulation mechanism 251E includes the variable chamber 252E communicating with the fourth passage 241E. The variable chamber 252E is partitioned from the variable chamber 220E of the second passage 221E by the partition member 255E that is movable according to a change in pressure of the reservoir chamber 18 on the upstream side or the second chamber 49 (see FIG. 2) on the downstream side when the piston 45 (see FIG. 1) moves in the extension direction.

The variable chambers 220E and 252E are disposed to overlap the second damping disc valve 222E in an axial direction of the second damping disc valve 222E. The pressure accumulation mechanism 251E including the variable chambers 220E and 252E is disposed to overlap the second damping disc valve 222E in the axial direction of the second damping disc valve 222E.

A hydraulic circuit diagram of the body valve 30E described above is similar to that of the body valve 30.

Next, main operations of the body valve 30E will be described.

During the extension stroke, a pressure in the second chamber 49 (see FIG. 2) becomes lower than a pressure in the reservoir chamber 18, and the oil fluid L in the reservoir chamber 18 is introduced into a first passage 211 and flows into the second chamber 49 (see FIG. 2) via a first damping force generation mechanism 215 (see FIG. 2). In addition to this, the oil fluid L in the reservoir chamber 18 is introduced from the fourth passage 241E into the variable chamber 252E of the pressure accumulation mechanism 251E and deforms the partition member 255E to expand the variable chamber 252E. At that time, the oil fluid L in the variable chamber 220E that is reduced in size is discharged to the second chamber 49 (see FIG. 2) through the second passage 221E.

During the extension stroke at a low speed in which a piston speed is lower than a predetermined value and at a low frequency in which a piston frequency is lower than a predetermined value, since a stroke of the piston 45 (see FIG. 1) is large, at the beginning of the introduction of the oil fluid L from the reservoir chamber 18 to the variable chamber 252E through the fourth passage 241E, the partition member 255E is largely bent, the partition disc 314 comes into contact with the protruding part 89 of the valve base 25, and thereby any further deformation is curbed. At that time, the disc spring 153E remains in contact with the outer circumferential tapered plate part 162E. Thereby, the variable chamber 252E is placed in a state in which an increase in volume is suppressed, and the variable chamber 252E can no longer absorb an increase in the oil fluid L being introduced. Then, a force of the oil fluid L in the reservoir chamber 18 pushing the first damping valve 212 in an opening direction becomes higher. Therefore, the first damping valve 212 opens and allows the oil fluid L to flow into the second chamber 49 (see FIG. 2) through the first passage 211. Therefore, during the extension stroke at a low speed in which the piston speed is lower than the predetermined value and at a low frequency in which the piston frequency is lower than the predetermined value, damping force characteristics are the same as in a case in which the pressure accumulation mechanism 251E is not provided.

On the other hand, even at a low speed in which the piston speed is lower than the predetermined value, during the extension stroke at a high frequency in which the piston frequency is equal to or higher than the predetermined value, since the stroke of the piston 45 (see FIG. 1) is small, a volume of the oil fluid L introduced from the reservoir chamber 18 into the variable chamber 252E through the fourth passage 241E is small. Therefore, the partition disc 314 also has a small amount of bending, and does not come into contact with the protruding part 89 of the valve base 25, or is deformable even if it does come into contact with it. Even at that time, the disc spring 153E remains in contact with the outer circumferential tapered plate part 162E. Therefore, most of the increase in the oil fluid L introduced from the reservoir chamber 18 into the variable chamber 252E through the fourth passage 241E is absorbed by the bending of the partition disc 314. Then, the force of the oil fluid L in the reservoir chamber 18 pushing the first damping valve 212 in an opening direction is further suppressed than that at the low frequency in which the piston frequency is lower than the predetermined value, and the damping force becomes lower and softer than that at the low frequency.

Also, at a high speed in which the piston speed is equal to or higher than the predetermined value, the opening/closing disc 152E deforms and separates from the partition disc 314 in a state in which the partition disc 314 is largely bent and brought into contact with the protruding part 89 of the valve base 25, and any further deformation is curbed. In other words, the relief mechanism 258E opens. At the same time, the outer circumferential tapered plate part 162E of the disc spring 153E is deformed and separated from the partition disc 314. In other words, the relief mechanism 331 opens. Thereby, the oil fluid L in the variable chamber 252E is allowed to flow into the second chamber 49 (see FIG. 2) through the second passage 221E including the variable chamber 220E. Further, any additional deformation of the opening/closing disc 152E is suppressed by coming into contact with the disc 311 at the time of the deformation described above.

During the compression stroke, a pressure in the second chamber 49 (see FIG. 2) becomes higher than a pressure in the reservoir chamber 18, and the oil fluid L in the second chamber 49 (see FIG. 2) is introduced into the second passage 221E and flows into the reservoir chamber 18 via the second damping force generation mechanism 225E. In addition to this, the oil fluid L in the second chamber 49 (see FIG. 2) is introduced into the variable chamber 220E of the pressure accumulation mechanism 251E and deforms the partition member 255E to expand the variable chamber 220E. At that time, the oil fluid L in the variable chamber 252E that is reduced in size is discharged into the reservoir chamber 18 through the fourth passage 241E.

During the compression stroke in which the piston frequency is lower than the predetermined value, since the stroke of the piston 45 (see FIG. 1) is large, at the beginning of the introduction of the oil fluid L from the second chamber 49 (see FIG. 2) into the variable chamber 220E, the partition member 255E is largely bent, the outer circumferential tapered plate part 162E of the disc spring 153E is brought into contact with the valve disc 154E, and any further deformation is curbed. Thereby, a volume of the variable chamber 220E remains unchanged, and the variable chamber 220E is no longer able to absorb the increase in the oil fluid L being introduced. Then, a pressure in the variable chamber 220E increases to a high pressure, and thus a force pushing the second damping disc valve 222E in the opening direction becomes higher. Therefore, the second damping disc valve 222E opens and allows the oil fluid L to flow into the reservoir chamber 18 through a gap between itself and the outer seat 88. Therefore, during the compression stroke at a low frequency in which the piston frequency is lower than the predetermined value, damping force characteristics are the same as in a case in which the pressure accumulation mechanism 251E is not provided.

On the other hand, during the compression stroke in which the piston frequency is equal to or higher than the predetermined value, since the stroke of the piston 45 (see FIG. 1) is small, and a volume of the oil fluid L introduced from the second chamber 49 (see FIG. 2) into the variable chamber 220E is small, the partition disc 314 also has a small amount of bending and is likely to be deformed. Therefore, most of the increase in the oil fluid L introduced into the variable chamber 220E from the second chamber 49 (see FIG. 2) is absorbed by the bending of the partition member 255E. Therefore, the pressure in the variable chamber 220E is low, and an opening pressure of the second damping disc valve 222E does not increase. Therefore, when the piston frequency is high, the damping force is lower and softer than when the piston frequency is low.

The shock absorber 11E of the sixth embodiment and the body valve 30E thereof achieve the same effects as in the first embodiment.

The structures of the first to sixth embodiments can be applied to various structures as long as they include a first passage through which a flow of the working fluid occurs due to movement of the piston in one direction, a second passage through which a flow of the working fluid occurs due to movement of the piston in the other direction, a first damping valve that opens and closes the first passage, and a second damping disc valve that opens and closes the second passage. That is, in the first to sixth embodiments, a case in which the second damping disc valves 222 and 222A to 222E and the pressure accumulation mechanisms 251 and 251A to 251E are respectively disposed to overlap each other on the reservoir chamber 18 side of the body valves 30 and 30A to 30E has been described as an example, but a structure in which, for example, the second damping disc valves 222 and 222A to 222E and the pressure accumulation mechanisms 251 and 251A to 251E and the like are respectively disposed to overlap each other on the second chamber 49 side of the body valves may be used. Also, the structure of the first to sixth embodiments can also be applied to the piston 45 (see FIG. 1). At that time, a structure in which the second damping disc valves 222 and 222A to 222E and the pressure accumulation mechanisms 251 and 251A to 251E are respectively disposed to overlap each other on the first chamber 48 side of the piston 45 may be used, and a structure in which the second damping disc valves 222 and 222A to 222E and the pressure accumulation mechanisms 251 and 251A to 251E are respectively disposed to overlap each other on the second chamber 49 side of the piston 45 may be used.

### INDUSTRIAL APPLICABILITY

According to the above-described aspects of the present invention, it is possible to provide a shock absorber and a damping valve device capable of suppressing occurrence of abnormal noise. Therefore, industrial applicability is high.

### REFERENCE SIGNS LIST

11, 11A to 11E Shock absorber
17 Cylinder
18 Reservoir chamber
30, 30A to 30E Body valve (damping valve device)
45 Piston
49 Second chamber
88 Outer seat (seat)
153, 153E Disc spring
154, 154E Valve disc
211 First passage
212 First damping valve
220, 220A to 220E Variable chamber
221, 221A to 221E Second passage
222, 222C to 222E Second damping disc valve
231 Third passage
241, 241C, 241E Fourth passage (communication passage)
251, 251A to 251E Pressure accumulation mechanism
252, 252A to 252E Variable chamber
255, 255A to 255E Partition member
258, 258B, 258D, 258E, 331 Relief mechanism

1. A shock absorber comprising:
a cylinder in which a working fluid is sealed;
a piston fitted in the cylinder and partitioning an inside of the cylinder;
a first passage through which a flow of the working fluid occurs due to movement of the piston in one direction;
a first damping valve providing resistance to a flow of the working fluid from a chamber on an upstream side to a chamber on a downstream side of the first passage;
a second passage through which a flow of the working fluid occurs due to movement of the piston in the other direction; and
a second damping disc valve providing resistance to a flow of the working fluid from a chamber on an upstream side to a chamber on a downstream side of the second passage, wherein
the second damping disc valve includes:
a third passage which allows constant communication between a chamber on an upstream side and a chamber on a downstream side; and
a fourth passage communicating with a chamber on an upstream side, and
a variable chamber communicating with the fourth passage and partitioned by a partition member, which is movable according to a change in pressure of a chamber on an upstream side or a downstream side, is disposed to overlap the second damping disc valve.

2. The shock absorber according to claim 1, wherein the third passage and the fourth passage are formed in a valve disc of the second damping disc valve seated on a seat.

3. The shock absorber according to claim 2, wherein
the partition member is formed of a disc spring, and
the variable chamber formed between the partition member and the valve disc increases during an extension stroke of the piston, and the variable chamber decreases during a compression stroke.

4. The shock absorber according to claim 1, wherein the partition member includes a relief mechanism which relieves an inside of the variable chamber after a differential pressure between chambers on an upstream side and a downstream side reaches a predetermined value.

5. The shock absorber according to claim 1, wherein the second damping disc valve is provided in a body valve.

6. The shock absorber according to claim 2, wherein the second damping disc valve is provided in a body valve.

7. The shock absorber according to claim 3, wherein the second damping disc valve is provided in a body valve.

8. The shock absorber according to claim 4, wherein the second damping disc valve is provided in a body valve.

9. A damping valve device which communicates with a cylinder in which a working fluid is sealed, comprising
a first passage through which a flow of the working fluid occurs due to movement of a piston in the cylinder in one direction;
a first damping valve providing resistance to a flow of the working fluid from a chamber on an upstream side to a chamber on a downstream side of the first passage;
a second passage through which a flow of the working fluid occurs due to movement of the piston in the other direction; and
a second damping disc valve providing resistance to a flow of the working fluid from a chamber on an upstream side to a chamber on a downstream side of the second passage, wherein
the second damping disc valve has a communication passage communicating with a chamber on an upstream side, and
a pressure accumulation mechanism having a variable chamber which communicates with the communication passage and is partitioned by a partition member, which is movable according to a change in pressure of a chamber on an upstream side or a downstream side, is disposed to overlap the second damping disc valve.
